(19) United States
(12) Patent Application Publication
(10) Pub. No.: US 2026/0065529 A1
(43) Pub. Date: Mar. 5, 2026

(54) GRAPHICS PROCESSING

(71) Applicant: Arm Limited, Cambridge (GB)

(72) Inventors: Daren Croxford, Swaffham Prior (GB); Roberto Lopez Mendez, Cambridge (GB); Mina Ivanova Dimova, Great Shelford (GB)

(73) Assignee: Arm Limited, Cambridge (GB)

(21) Appl. No.: 18/818,340

(22) Filed: Aug. 28, 2024

(51) Int. Cl. G06T 11/00; G06T 11/20

(52) U.S. Cl. CPC G06T 11/10; G06T 11/20; G06T 2210/36; G06T 2210/62

(57) ABSTRACT

Disclosed is a method of operating a graphics processor to generate a render output. A first initial processing pass is performed to determine texture visibility information at respective sampling positions within the render output. This texture visibility information is then used to control how texture data is obtained during a subsequent further processing pass that generates the render output.

### BACKGROUND

The technology described herein relates to graphics processing, and in particular to the operation of a graphics processor (graphics processing unit, “GPU”) when generating a render output.

Graphics processing is normally carried out by first dividing the graphics processing (render) output to be rendered, such as a frame to be displayed, into a number of similar basic components of geometry to allow the graphics processing operations to be more easily carried out. These basic components of geometry may often be referred to graphics “primitives”, and such “primitives” are usually in the form of simple polygons, such as triangles, points, lines, etc. (or groups thereof).

Each primitive (e.g. polygon) is at this stage defined by and represented as a set of vertices. Each vertex for a primitive has associated with it a set of data (such as position, colour, texture and other attributes data) representing the vertex. This “vertex data” is then used, e.g., when rasterising and rendering the primitive(s) to which the vertex relates in order to generate the desired render output of the graphics processing.

Once primitives and their vertices have been generated and defined, they can be processed by the graphics processor, in order to generate the desired graphics processing output (render output/target), such as a frame for display. This basically involves determining which sampling positions of an array of sampling positions associated with the render output area to be processed are covered by a primitive, and then determining a respective output value for each sampling position to represent the primitive at that sampling position (the respective output value for a sampling position thus defining the, e.g., appearance that sampling position should have (in terms of its colour, etc.)). These processes are commonly referred to as rasterising and rendering, respectively. (The term “rasterisation” is sometimes used to mean both primitive conversion to sample positions and rendering. However, herein “rasterisation” will be used to refer to converting primitive data to sampling position addresses only.)

These processes are typically carried out by testing sets of one, or of more than one, sampling position, and then generating for each set of sampling positions found to include a sampling position that is inside (covered by) the primitive in question (being tested), a discrete graphical entity usually referred to as a “fragment” on which the graphics processing operations (such as rendering) are carried out. Covered sampling positions are thus, in effect, processed as fragments that will be used to render the primitive at the sampling positions in question. The “fragments” are the graphical entities that pass through the rendering process (the rendering pipeline). Each fragment that is generated and processed may, e.g., represent a single sampling position or a set of plural sampling positions, depending upon how the graphics processing system is configured.

A “fragment” is therefore effectively (has associated with it) a set of primitive data as interpolated to a given output space sampling position or points of a primitive. It may also include per-primitive and other state data that is required to shade the primitive at the sampling position (fragment position) in question.

Each graphics fragment may typically be the same size and location as a “pixel” of the output (e.g. output frame) (since as the pixels are the singularities in the final display, there may be a one-to-one mapping between the “fragments” the graphics processor operates on (renders) and the pixels of a display). However, it can be the case that there is not a one-to-one correspondence between a fragment and a display pixel, for example where particular forms of post-processing, such as downsampling, are carried out on the rendered image prior to displaying the final image. It is also the case that as multiple fragments, e.g. from different overlapping primitives, at a given location may affect each other (e.g. due to transparency and/or blending), the final pixel output may depend upon plural or all fragments at that pixel location.

Correspondingly, there may be a one-to-one correspondence between the sampling positions and the pixels of a display, but more typically there may not be a one-to-one correspondence between sampling positions and display pixels, as downsampling may be carried out on the rendered sample values to generate the output pixel values for displaying the final image. Similarly, where multiple sampling position values, e.g. from different overlapping primitives, at a given location affect each other (e.g. due to transparency and/or blending), the final pixel output will also depend upon plural overlapping sample values at that pixel location.

It is common in graphics processing systems, as part of the rendering process, to generate output values (e.g. colours) for sampling positions in a render output (e.g. image to be displayed) by applying so-called graphics “textures” or “texture data” to the surfaces to be drawn. Such graphics textures are typically applied by storing an array of texture elements or “texels”, each representing given texture data (such as colour, alpha, luminance and/or light/shadow, etc., values), and then mapping the texels onto the corresponding elements, such as (and typically), a set of sampling positions, for the render output in question (e.g. image to be displayed).

Thus a graphics texture will typically be configured as an array of data elements (texture elements (texels)), each having a corresponding set of texture data stored for it. The texture data for a given position within the texture is then determined by sampling the texture at that position (e.g. by using a suitable interpolation process). The stored arrays of texture elements (data) are typically referred to as “texture maps”.

The texture data is typically stored in (external) (e.g. main) memory. When texture data is needed by a graphics processor (e.g. for rendering an image to be displayed), the texture data required for the rendering process is thus usually first fetched from the memory where it is stored and loaded into a cache (e.g. a texture cache) of or accessible to the graphics processor, with the graphics processor (and in particular the rendering pipeline implemented by the graphics processor) then reading the texture data from the texture cache for use to perform the desired texturing operations.

The texture data is typically stored in the (external) (e.g. main) memory in a compressed format. Thus, when the graphics processor causes texture data to be fetched from the memory location where it is stored, the texture data must typically then be decompressed into a suitable (i.e. uncompressed) format for use by the graphics processor. It is not generally known in advance which texture data will be required by a given rendering process, and so the texture data should be, and generally is, compressed in such a manner that allows “random access” to the compressed texture data. This random access is typically achieved using block-based compression. Various texture compression algorithms are known in this regard that are designed for compressing texture data. For instance, one example of an efficient texture compression scheme is Arm's adaptive scalable texture compression (ASTC) technique, e.g. as described in U.S. Pat. No. 9,058,637 (Arm Limited), but various other compression schemes exist that can also suitably be used for compressing texture data including, but not limited to, Ericsson Texture Compression (ETC), PowerVR Texture Compression (PVRTC), S3 Texture Compression (S3TC), etc., and a graphics processor (graphics processing unit, GPU) may typically support one or more texture compression schemes.

The present Applicants however believe that there remains scope for improvements to the operation of a graphics processor (graphics processing unit, GPU) when generating a render output.

### BRIEF DESCRIPTION OF DRAWINGS

Various embodiments will now be described by way of example only and with reference to the following figures, in which:

FIG. 1 shows schematically an exemplary data processing system in which the technology described herein may be implemented;

FIG. 2 shows schematically an embodiment of a graphics processor including a texture mapping unit that interfaces with a texture cache system that is used to handle graphics processor texturing requests;

FIG. 3 shows the texture mapping unit of the graphics processing system of FIG. 2 in more detail;

FIG. 4 shows an example of graphics texture data;

FIG. 5 shows schematically texture filtering operations that may be performed by the texture mapping unit;

FIG. 6 shows an exemplary sequence of layers of neural network processing comprising an input layer and an output layer, between which are neural network layers comprising various convolutional layer (C-layer) layers and fully-connected layers (FC layer);

FIG. 7 illustrates a sequence of layers of neural network processing, wherein the output feature map from a layer of neural network processing may be written to a suitable buffer and then use as an input feature map for a next layer in the sequence, and wherein each layer of neural network processing may use processing parameters (e.g. such as weights) which are read from a suitable buffer;

FIG. 8 shows schematically training of a neural network to perform graphics texture compression according to an embodiment;

FIG. 9 shows an example of neural network based graphics texture decompression that may be performed according to an embodiment;

FIG. 10 shows schematically an example of a graphics processor (graphics processing unit, “GPU”) that may be used according to an embodiment;

FIG. 11 shows further details of the fragment thread creation process according to more traditional graphics processor operation;

FIG. 12 is a flow chart illustrate the rendering operation according to an embodiment;

FIG. 13 shows the fragment thread creation process according to an embodiment;

FIG. 14 shows an example of how a rendering pass may be performed according to more traditional graphics processor operation in which the rendering tile is processed according to scan line order;

FIG. 15 shows another example of how a rendering pass may be performed according to more traditional graphics processor operation in which the rendering tile is processed according to Morton (“Z”) order;

FIG. 16 shows an example tile to be rendered in which there are three primitives within that tile;

FIG. 17 shows the results of an initial processing pass according to the technology described herein in which a depth buffer and corresponding fragment visibility buffer are generated;

FIG. 18 shows how the fragment visibility information generated by the initial processing pass can be used to determine which graphics textures are visible at which sampling positions within the tile;

FIG. 19 shows a set of texture visibility information that can be generated by the initial processing pass;

FIG. 20 shows an example of how the order in which sampling positions can be controlled during the further processing pass;

FIG. 21 shows example heuristics that may be used according to an embodiment to control the order in which sampling positions are processed;

FIG. 22 is a flow chart showing an example of how the operation of the texture cache system may be controlled during the further processing pass;

FIG. 23 shows another example tile to be rendered in which there are six primitives with that tile;

FIG. 24 shows the results of an initial processing pass according to the technology described herein in which a fragment visibility buffer is generated; and

FIG. 25 is a flow chart showing an example of how neural network based texture processing may be controlled during the further processing pass.

Like numerals are used for like features in the drawings where appropriate.

### DETAILED DESCRIPTION

A first embodiment of the technology described herein comprises a method of operating a graphics processing system comprising a graphics processor operable to generate render outputs and a texture data processing system including a texture cache that is operable to transfer graphics texture data between a memory system in which graphics texture data is stored and the graphics processor, the method comprising:
for a sequence of primitives to be processed for a render output:
the graphics processor:
performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
thereafter performing a further processing pass to generate respective output values for the respective sampling positions within the render output, the further processing pass comprising, for respective sampling positions for which an output value is to be generated, performing further processing of the particular primitive in the sequence of primitives that is visible at that sampling position to generate a respective output value for the sampling position, the further processing including the graphics processor obtaining graphics texture data associated with the primitive from the texture data processing system and applying the obtained graphics texture data to the sampling position,
wherein a set of information is generated from the processing of the sequence of primitives by the initial processing pass that is usable to identify which graphics texture data is to be applied during the further processing pass at which sampling positions within the render output,
and wherein the method further comprises:
controlling how the graphics texture data that is to be applied to one or more sampling positions within the render output during the further processing pass is obtained from the texture data processing system based on the set of information generated from the processing of the sequence of primitives by the initial processing pass.

A second embodiment of the technology described herein comprises a graphics processing system comprising:
a graphics processor operable to generate render outputs; and
a texture data processing system including a texture cache that is operable to transfer graphics texture data between a memory system in which graphics texture data is stored and the graphics processor,
wherein the graphics processor comprises:
a rendering circuit that is operable to process primitives into respective sets of one or more fragments, each fragment associated with a respective set of one or more sampling positions within the render output, and which rendering circuit is further operable to process the resulting fragments to generate respective output values for the respective sampling positions within the render output; and
a rendering control circuit that is configured to control the operation of the graphics processor to generate a render output, wherein:
for a sequence of primitives to be processed for a render output:
the rendering control circuit causes the graphics processor to process the sequence of primitives by, using the rendering circuit:
   performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
   thereafter performing a further processing pass to generate respective output values for the respective sampling positions within the render output, the further processing pass comprising, for respective sampling positions for which an output value is to be generated, performing further processing of the particular primitive in the sequence of primitives that is visible at that sampling position to generate a respective output value for the sampling position, the further processing including the graphics processor obtaining graphics texture data associated with the primitive from the texture data processing system and applying the obtained graphics texture data to the sampling position,
   the graphics processing system further comprising a texturing control circuit that is configured to:
      when the graphics processor is performing a further processing pass for a sequence of primitives for which a corresponding initial processing pass has already been performed, wherein a set of information is generated from the processing of the sequence of primitives by the initial processing pass that is usable to identify which graphics texture data is to be applied during the further processing pass at which sampling positions within the render output,
      in response to requests from the graphics processor for instances graphics texture data from the texture data processing system:
      control how the graphics texture data that is to be applied to one or more sampling positions within the render output during the further processing pass is obtained from the texture data processing system based on the set of information generated from the processing of the sequence of primitives by the initial processing pass.

The technology described herein relates to graphics processing systems including graphics processors and in particular that include graphics processors that, when generating a render output (e.g. frame), are operable and configured to effectively render primitives within a sequence of primitives that is to be processed for the render output (frame) in two separate processing passes.

For instance, as will be explained further below, the graphics processor according to the technology described herein, when processing a given sequence of primitives that is to be processed for a given render output, does so by first performing an “initial” processing pass in which primitives within the sequence of primitives are processed at least so far as to determine which primitives are (potentially) visible at which sampling positions within the render output, but wherein at least some of the final rendering operations that are to be performed to generate the respective (rendered) output values for the respective sampling positions within the render output including, e.g. applying any graphics texture data to those sampling positions, and writing out the (rendered) output values to storage, are deferred to a subsequent “further” processing pass.

In embodiments, therefore, the rendering process is performed by a rendering pipeline, in which a series of processing stages are performed, but the rendering pipeline is implemented by performing separate “initial” and “further” processing passes (with at least some of the later stages of the rendering pipeline effectively deferred to the further processing pass).

One or more primitives that were processed during an initial processing pass will thus be processed again during the corresponding, subsequent further processing pass, with the further processing pass performing suitable further processing of those primitives, as appropriate, e.g., and in particular, to ‘complete’ the rendering of those primitives and generate the desired (rendered) output values for the respective sampling positions at which those primitives are visible.

For example, according to the technology described herein, the initial processing pass generally comprises processing primitives into sets of one or more fragments, each fragment associated with one or more sampling positions within the render output (e.g. by rasterising the primitives), and then processing the resulting fragments to determine which fragments, and hence which primitives, are visible for which sampling positions within the render output.

The initial processing pass according to the technology described herein thus effectively determines which particular primitives in the sequence of primitives are visible at which sampling positions within the render output (or at least which primitives are visible based on the processing performed up to that point).

This fragment visibility determination during the initial processing pass may be done, for example, by depth testing the fragments against a suitable depth (Z) buffer that is also populated during the initial processing pass, e.g. in the normal manner for such depth (Z) testing. As will be discussed further below, there may be further fragment processing stages during the initial processing pass after the (early) depth testing stage (such as late depth testing, etc., as desired). In embodiments, however, the fragment processing during the initial processing pass does not continue as far as to generate the ultimate (rendered) output values for the respective sampling positions within the render output, as the generation of the (rendered) output values is instead deferred to the corresponding further processing pass.

Accordingly, once such initial processing pass has been performed for a given sequence of primitives (i.e. there are no further primitives in the sequence of primitives to be processed, such that the initial processing pass for that sequence of primitives has finished), a corresponding further processing pass is then performed in respect of that same sequence of primitives, i.e. to complete the rendering process and generate the desired render output.

Thus, as mentioned above, the further processing pass according to the technology described herein generates the respective (rendered) output values for the respective sampling positions within the render output.

This is in embodiments done by processing the respective, different sampling positions in turn and generating a respective (rendered) output value for each sampling position being processed.

Thus, during the further processing pass, for a particular current sampling position that is being processed by the further processing pass, the processing that is performed in respect of that sampling position in embodiments comprises determining which particular primitive in the sequence of primitives is visible at that sampling position and then further processing that primitive in respect of that sampling position to generate a respective (rendered) output value for the sampling position.

In this respect, it will be appreciated that the determination of which particular primitive in the sequence of primitives is visible at a particular sampling position can be (and in embodiments is) done based on the results of the fragment visibility determination during the initial processing pass. For instance, as will be explained further below, the initial processing pass in embodiments generates a set of primitive identifying information indicating, for each sampling position within the render output, the particular primitive that is visible at that sampling position. This set of primitive identifying information can accordingly be used during the further processing pass to quickly identify which particular primitives are visible at which sampling positions.

Once it is determined which particular primitive in the sequence of primitives is visible at the particular current sampling position being processed, further processing of that primitive is then performed in respect of the current sampling position including, for example, converting the primitive into a respective fragment associated with the sampling position, and then performing suitable fragment processing operations to generate the respective (rendered) output value for the sampling position. As will be explained further below, these fragment processing operations may, e.g., and in embodiments do, include executing one or more fragment shader (program(s)) and then (in embodiments, as part of the fragment shader (program) execution) applying graphics texture data, as appropriate, to that sampling position to generate respective (rendered) output values, as well as writing out the respective (rendered) output value to storage.

The effect and benefit of rendering primitives in this manner, i.e. in two separate processing passes, as discussed above, is that the further processing pass can then be (and according to the technology described herein is) controlled based on the information gathered from the processing of the sequence of primitives during initial processing pass, e.g., to provide an improved, e.g., overall more efficient, graphics processor operation. That is, although performing two separate passes may mean that some additional processing overhead is introduced, the overall graphics processing operation may nonetheless be improved, as the information gathered from the initial processing pass operation can be used in various ways to control, and hence (try to) optimise the processing during the further processing pass.

In particular, according to embodiments of the technology described herein, a set of information is generated from the processing of the sequence of primitives by the initial processing pass that is usable to identify which graphics texture data is to be applied during the further processing pass at which sampling positions within the render output, and this set of information is then used to control how the graphics texture data is processed during the further processing pass.

For instance, as mentioned above, the (final) fragment processing (rendering) operations that are performed in respect of a particular sampling position to generate the respective (rendered) output value for that sampling position (and which operations are according to the technology described herein deferred to the further processing pass) may, e.g., and typically do, include executing one or more fragment shader (program), and then (in embodiments, as part of the fragment shader (program) execution) applying graphics texture data to the sampling position in question, as appropriate.

The graphics texture data is in embodiments stored in a memory system, which may, e.g., and in embodiments does, comprise a memory that is external to the graphics processor (e.g. main memory). When executing a graphics processing program for which a texturing operation is to be performed, the graphics processor can thus (and does) request graphics texture data for the texturing operation from the (external) memory system, as required, with the requested graphics texture data then being returned to the graphics processor accordingly for use by the graphics processor. Thus, the graphics processing system in embodiments further comprises such (external) memory system for storing graphics texture data.

This transfer of graphics texture data from the (external) memory system in which the graphics texture data is stored into the graphics processor may be, and in embodiments is, facilitated by the use of a dedicated “texture mapping unit” of the graphics processor that is operable to receive texturing requests (requests for texture data) from a graphics processor programmable execution unit and process these texturing requests accordingly. The texture mapping unit is thus a dedicated unit (circuit) associated with, and local to, the graphics processor that provides an interface to the (external) memory system in which the texture data is stored and that is accordingly operable and configured to process any texturing requests issued from the graphics processor programmable execution unit for graphics texture data and return the requested graphics data to the graphics processor programmable execution unit.

In embodiments, the texture mapping unit interfaces, and connects, to a “texture cache system” that is operable to transfer graphics texture data stored in the memory system to the graphics processor for use by the graphics processor when generating a render output (which texture mapping unit is thus operable to receive (load) texture data from the texture cache system and use that texture data to perform texturing operations). That is, rather than the texture data being transferred directly from the (external) memory system to the graphics processor, the texture data is in embodiments transferred via the texture cache (which may itself be part of a larger cache system that is used for transferring such data between the graphics processor and memory). This can then help reduce storage and bandwidth requirements associated with the storage and accessing of the graphics texture data in use.

To perform the required graphics texturing operations, the required graphics texture data may thus need to be fetched in from an (external) memory system (where the texture data is stored). The graphics texture data is typically stored in the (external) memory system in a compressed format, such that the graphics texture data may also need to be first suitably decompressed for use by the graphics processor. Thus, the (compressed) graphics texture data, once obtained from memory, may need to be further processed to convert the graphics texture data from the (compressed) format in which it is stored in memory into a suitable and desired (uncompressed) format for use by the graphics processor.

Suitable decompression circuitry may thus be provided for performing the required decompression of the graphics texture data.

In embodiments, the texture cache system also includes suitable decompression circuitry for performing the further processing, i.e. decompression, of the graphics texture data, as needed. Thus, in embodiments, the texture cache system also performs the required decompression of texture data as and when it is fetched from the (external) memory system. Other arrangements would however be possible. For instance, in other embodiments, the further processing, i.e. decompression, of the texture data may be performed by another circuit of the graphics processor (this may particularly be the case when the decompression is performed by executing one or more neural network(s) in which case the required decompression of texture data may be performed by a suitable neural engine within the graphics processor (and that is operable to communicate with the texture cache system).

Various other processing of the graphics texture data may be performed before it is applied to the relevant sampling position(s) (and this further processing may generally be performed within the texture cache system, within the texture mapping unit (e.g. where the further processing comprises texture filtering), or elsewhere within the graphics processor, as appropriate).

The texture mapping unit (where present) and the texture cache system, as well as any other processing (e.g. decompression) circuitry that may be used to process texture data before it is provided for use by the graphics processor may thus together form part of a “texture data processing system” (which texture data processing system may include any suitable and desired arrangements of the texture mapping unit and texture cache system) that is operable and configured to handle texturing requests from the graphics processor. Thus, any requests for texture data that is stored in the memory system that are generated by the graphics processor programmable execution unit are in embodiments handled via such texture data processing system (such that the graphics processor (programmable execution unit) in embodiments sends texturing requests to such texture data processing system, e.g., and in embodiments, to a texture mapping unit of such texture data processing system, and correspondingly receives texturing responses including the requested texture data from such texture data processing system (rather than directly to/from the (external) memory system)).

During the further processing pass, therefore, in order to apply graphics texture data to a particular sampling position, the graphics processor (programmable execution unit) may thus issue a suitable ‘texturing request’ to the texture data processing system obtain the required instance of graphics texture data, and this texturing request may then trigger various processing of the graphics texture data by the texture data processing system, including reading the relevant graphics texture data in from its location in memory (e.g. if it not already available more locally within the texture cache system), and then any performing further processing, i.e. decompression, of the graphics texture data, as needed, to convert the graphic texture data into a suitable format for use by the graphics processor. The requested graphics texture data is then suitably returned to the graphics processor from the texture data processing system, and applied to the appropriate sampling position(s).

A ‘texturing request’ issued by the graphics processor will thus typically, and in embodiments, specify a particular instance of graphics texture data that is to be returned (i.e. a respective ‘type’ of graphics texture) and also one or more levels of detail (i.e. resolution(s)) at which the graphics texture data is required. In this respect, it will be appreciated that the level or levels of detail at which the graphics texture is to be applied may be determined in various ways.

For example, the graphics texture data will often (and in embodiments is) be stored as a set of mipmap levels, with the different mipmap levels representing different resolution versions of the same graphics texture. The application may in some instances specify a particular level or multiple levels of detail to be used (in which case the mipmap level or levels that are used are essentially fixed by the application). Alternatively, the mipmap level or levels to be used may be determined dynamically on a per-region basis based on screen space co-ordinates of adjacent fragments, optionally with an application specified bias.

In whichever manner the level of detail is determined, the corresponding ‘texturing request’ that is generated in respect of the graphics texture data will in embodiments then specify a desired level or levels of detail for the graphics texture data (with the texturing request then being serviced accordingly, e.g. by returning the graphics texture data at the specified level(s) of detail).

It will be appreciated that fetching the required graphics texture data has an associated bandwidth cost. There may also be significant bandwidth costs associated with fetching in any data or data structures that are required for the further processing (i.e. decompression) of the graphics texture data. For instance, this may particularly be the case where some or all of the processing of the graphics texture data is performed using a set of one or more neural networks, as will be explained further below, in which case various neural network data or data structures may first need to be loaded into the graphics processor to perform the desired neural network processing (which data (structures) may include the neural network model itself, but may also include the weights, biases, etc., for the specific instance of neural network execution that is to be performed).

In addition to the bandwidth costs for fetching in any required data for the graphics texturing operations, there may also be processing ‘bubbles’ (i.e. latency), as the graphics processor may effectively stall waiting for the required graphics texture data to be available (and in the correct format for use), which may result in reduced processing efficiency and/or increased latency.

As alluded to above, to facilitate such graphics texturing operations, the graphics texture data may therefore be, and in embodiments is, accessed via a suitable “texture cache system” that is operable to transfer graphics texture data stored in the memory system to the graphics processor for use by the graphics processor.

That is, rather than the texture data being transferred directly from the (external) memory system to the graphics processor, the texture data is in embodiments transferred via the texture cache (which may itself be part of a larger cache system that is used for transferring such data between the graphics processor and memory). This can therefore speed up memory accesses and/or reduce memory bandwidth, e.g. in the normal manner for such (texture) cache operation.

Thus, at least some graphics texture data may be stored more locally to the graphics processor (e.g. in such texture cache system).

Accordingly, when the graphics processor issues a texturing request for an instance of graphics texture data that is already available locally to the graphics processor (e.g. there is a ‘hit’ in the texture cache system for that graphics texture data), the required graphics texture data can thus be returned to the graphics processor directly from its location in the more local storage in the texture cache system, i.e. without having to access (external) memory.

That is, when an instance of graphics texture data is required during the further processing pass, the graphics processor generates a suitable texturing request in respect of that instance of graphics texture data (i.e. a request for that particular (type of) graphics texture at a specified level (or levels) of detail, etc.), which texturing request is then issued to the texture data processing system (in embodiments via the texture mapping unit thereof, as discussed above). This texturing request in embodiments then triggers a lookup for that instance of graphics texture data in the texture cache system.

If the requested instance of graphics texture data is already present in the texture cache system, it can then be (and is) returned accordingly from its location in the more local storage in the texture cache system (i.e. without having to access (external) memory). On the other hand, if the requested instance of graphics texture data is not already present in the texture cache system, the required graphics texture data may then be (and typically is) fetched into the texture cache system from its location in (external) memory (and is then returned from the texture cache system to the graphics processor accordingly once it is available), e.g. in the normal manner for such (texture) cache operation.

In more traditional texture cache operation, the texture cache lookup may be performed on both the (type of) graphics texture and the specified level(s) of detail and so if the particular requested instance of graphics texture data at the specified level(s) of detail is not already present in the texture cache system, this may trigger the fetching of the required instance of graphics texture data at the specified level(s) of detail from (external) memory (i.e. this may trigger the texture cache ‘miss’ operation).

The present Applicants recognise however that even if the particular instance of graphics texture data at the specified level(s) of detail for a particular texturing request is not already present in the texture cache system, in some circumstances it may be still be acceptable to return the graphics texture data that is already present in the texture cache system, e.g., and in embodiments, so long as it can be determined that doing this will not significantly compromise the (visual) acceptability of the overall render output that is being generated. This then has the benefit of being able to (re-use) some or all the graphics texture data that is already present in the texture cache system, even if the stored graphics texture data is not an exact match for the texturing request, thus avoiding having to always fetch in new graphics texture data whenever the specific instance of graphics texture data that is being requested is not present (and hence this may reduce the processing burden and/or memory bandwidth associated the texturing operations when it is possible to do so).

For instance, if an instance of the (same) required (type of) graphics texture data that is the subject of a particular texturing request is present in the texture cache system, but the instance of graphics texture data that is already present in the texture cache system is at a level of detail other than the level(s) of detail which is specified by the particular texturing request being serviced, in some cases it may still be acceptable or appropriate to return the graphics texture data at the other level of detail, as this difference in quality in the final render output may not be readily perceptible to the user.

An example of this would be when the instance of (same) graphics texture data that is already present in the texture cache system is of a higher level of detail (i.e. higher quality) than the level(s) of detail specified by the particular texturing request being serviced. In that case, using the higher quality graphics texture data should not compromise (visual) acceptability of the overall render output that is being generated, and so this should always be acceptable. Further, as discussed above, being able to (re-)use the (higher quality) graphics texture data that is already available in the texture cache system may help reduce the memory bandwidth and/or processing burden associated with servicing the texturing request, since the data is in embodiments already available.

Thus, in embodiments, when an instance of graphics texture data is to be applied to a sampling position during the further processing pass, the graphics processor issues to the texture data processing system a corresponding texturing request for that instance of graphics texture data, the texturing request thus specifying a particular graphics texture that is required and one or more level(s) of detail at which that particular graphics texture is required. The texturing request in embodiments then causes a corresponding lookup to the texture cache system.

Thus, in response to such texturing request, it is then determined (by an appropriate texture cache lookup unit (circuit) of the texture data processing system) whether the particular requested graphics texture is already available in the texture cache system at the specified level(s) of detail.

When it is determined that the particular requested graphics texture is already available in the texture cache system at the specified level(s) of detail, the particular requested graphics texture can then be (and is) accordingly returned to the graphics processor at the specified level(s) of detail.

Whereas, when it is determined that the particular requested graphics texture is not already available in the texture cache system (at any level of detail), the particular requested graphics texture (at the specified level(s) of detail) may then be fetched from (external) memory into the texture cache system, e.g. in the normal manner for the texture cache ‘miss’ operation.

In more traditional texture cache operation, if the particular requested graphics texture is not already available in the texture cache system is not available at the specified level(s) of detail, this may also trigger the texture cache ‘miss’ operation, i.e. to fetch in the specified level(s) of detail.

According to embodiments, however, when it is determined that the particular requested graphics texture is already available in the texture cache system but at a level of detail other than the specified level(s) of detail, rather than this automatically triggering the texture cache ‘miss’ operation, it is in embodiments first determined whether or not the graphics texture data that is already available in the texture cache system can (and should) be returned at the other level of detail.

In particular, if the (same) particular requested graphics texture is available in the texture cache system but at a higher level of detail than the level(s) of detail specified by the texturing request (i.e. at a higher quality), it may then be appropriate to return the higher quality graphics texture data, and this is in embodiments done. For example, returning the higher quality graphics texture data will not (negatively) impact the overall (visual) acceptability of the render output, but may significantly reduce processing burden and/or bandwidth by avoiding having to fetch in the (same) graphics texture data at the different specified level of detail.

Thus, in embodiments, in response to a texturing request for a particular instance of graphics texture data, when it is determined that the particular requested graphics texture is already available in the texture cache system at a level of detail that is higher than the level(s) of detail specified by the texturing request:
the method comprises (and the texture cache lookup unit (circuit) performs such method of):
returning the graphics texture at the higher level of detail to the graphics processor.

Thus, in addition to returning the stored graphics texture when there is a ‘hit’ on both graphics texture type and level(s) of detail, as may traditionally be done, the technology described herein in embodiments also returns the stored graphics texture data when there is a hit on graphics texture type and the level of detail is higher than the level(s) of detail specified by the texturing request.

The present Applicants further recognise that even when the graphics texture data that is already available in the texture cache system is of a lower level of detail (i.e. lower quality) than the level of detail which is specified by the particular texturing request being serviced, it may nonetheless still be acceptable to return the graphics texture data at the lower level of detail in response to the texturing request, so long as this does not significantly compromise the (visual) acceptability of the overall render output that is being generated. For example, this may be the case where the graphics texture data is to be applied at sampling positions where it can be determined that the graphics texture data will have a relatively lower (visual) impact on the overall render output being generated.

Thus, in embodiments, in response to a texturing request for a particular instance of graphics texture data, when it is determined that the particular requested graphics texture is already available in the texture cache system at a level of detail that is lower than the level(s) of detail specified by the texturing request:
the method comprises (and the texture cache lookup unit (circuit) performs such method of):
further determining whether or not the graphics texture should be returned to the graphics processor at the lower level of detail.

When the result of the further determination is that the graphics texture should be returned to the graphics processor at the lower level of detail, the graphics texture data is accordingly returned. Whereas, when the result of the further determination is that the graphics texture should not be returned to the graphics processor at the lower level of detail, the texture cache ‘miss’ operation is triggered to fetch the particular requested graphics texture data at the specified level(s) of detail.

Thus, in embodiments, the texture data processing system, when processing a texturing request issued by the graphics processor (programmable execution unit), is operable to determine whether the texture cache lookup should be handled in the normal (traditional) manner, e.g. by causing the texture cache to return the particular requested graphics texture data at the specified level(s) of detail, or whether the texture cache lookup can be performed differently, e.g. by allowing the texture cache to return the particular requested graphics texture data at a different (e.g. lower) level of detail, if it is beneficial to do so, i.e. because that data is already available and it is acceptable to re-use that data.

As mentioned above, the further determination as to whether or not the graphics texture data should be returned to the graphics processor at the lower level of detail in embodiments is based on a determination of the (visual) impact of the graphics texture data on the overall render output being generated. In embodiments, this determination of the (visual) impact of the graphics texture data on the overall render output being generated is performed based on the results of the initial processing pass, and further details of this will be presented below. Thus, in embodiments, the initial processing pass determines information as to the relative (visual) impact of the different instances of graphics texture data on the overall render output being generated and this information is then provided to the texture data processing system for use thereby in order to control how texture data is obtained in response to a particular texturing request.

In this regard, the present Applicants recognise that the relative (visual) impact of graphics texture data that is to be applied at a particular set of sampling positions during the further processing pass may advantageously be determined based on the information that is gathered during the initial processing pass.

For example, as will be described further below, if it can be determined that an instance of graphics texture data is only to be applied to relatively few sampling positions and/or at sampling positions that only appear in peripheral regions of the render output, this may mean that the graphics texture data will have relatively lower (visual) impact, which may in turn mean that it is acceptable to return whichever graphics texture data is already available in the texture cache system (even if that is of lower quality), rather than having to fetch in the graphics texture data at the correct level of detail as specified by the texturing request.

In this way, the texture data processing that is performed in response to a texturing request (and in particular what is returned in response to a texturing request) issued during a further processing pass can be (and in embodiments is) controlled based on a set of information that is generated from the processing of the sequence of primitives by the corresponding initial processing pass. In particular, as will be explained further below, the set of information generated from the processing of the sequence of primitives by an initial processing pass is usable to identify which graphics texture data is to be applied during the further processing pass at which sampling positions within the render output, and hence can be used to determine the (expected) relative (visual) impact of particular instances of graphics texture data. This information can then be used to perform the further determination discussed above.

The examples above primarily relate to re-using graphics texture data at different levels of detail (when it is appropriate or acceptable to do so). it will be appreciated that similar considerations may apply to other data or data structures that may be used when processing graphics texture data.

For instance, when the graphics processing system is operable and configured to support neural network based texture processing in which when compressed graphics texture data is loaded into the graphics processor during the further processing pass, the graphics texture data is processed into an uncompressed format for use by the graphics processor by one or more neural network(s), as mentioned above, various neural network data or data structures may first need to be loaded into the graphics processor to perform the desired neural network processing (which data (structures) may include the neural network model itself, but may also include the weights, biases, etc., for the specific instance of neural network execution that is to be performed).

The texture data processing system thus in embodiments comprises or has access to appropriate storage for storing the required data or data structures for executing such neural networks. This storage may be any suitable local storage. For example, this could be dedicated storage for such neural network data structures but could also be storage that is available for other data, as needed. Similarly, this storage may reside at any suitable location within the graphics processing system. For example, this storage may reside within the texture cache system when the neural network based texture processing is performed within the texture cache system. Alternatively, the storage may reside within the graphics processor when the neural network based texture processing is performed by an appropriate neural network processing unit of the graphics processor, which neural network processing unit is in embodiments able to communicate with the texture cache system, as needed. Various other arrangements would be possible for supporting such neural network based texture processing within a graphics processing system. In whichever manner it is provided the overall texture data processing system described above in embodiments comprises or has access to this storage.

Thus, in embodiments, where graphics texture data is stored in the memory system in compressed format, and where the graphics processor supports neural network based texture processing in which when compressed graphics texture data is loaded into the graphics processor during the further processing pass, the graphics texture data is processed into an uncompressed format for use by the graphics processor by one or more neural network(s), the texture data processing system in embodiments comprises or has access to (local) storage for storing the required data or data structures for executing the one or more neural network(s).

As will be explained further below, different neural networks may be configured for processing different types of graphics texture data. In some cases, different neural networks may be configured for processing different levels of detail of the same type(s) of graphics texture data.

Thus, in general, in order to process (i.e. decompress) a particular instance of graphics texture data, at a particular level (or levels) of detail, an appropriately configured set of neural network(s) should be used to do this. Thus, before executing the neural network(s) to perform the required neural network texture processing, the relevant data and data structures corresponding to the particular set of neural network(s) that are configured for the particular instance of graphics texture data should first be loaded into the appropriate (local) storage.

Having to fetch in all of the data (structures) for the appropriate neural network can therefore again increase processing latency and/or bandwidth.

The present Applicants thus recognise that in some cases, e.g., and in particular, where the particular instance of graphics texture data that is to be processed can be determined to have a relatively lower expected (visual) impact, it may be appropriate or acceptable to re-use some or all of the neural network data (structures) that are already available in the (local) storage, even if these do not correspond to the particular neural network(s) that are specifically configured for processing the particular instance of graphics texture data (and requested level(s) of detail, etc.) that is to be processed.

For example, if the neural network data (structures) that are currently available in the (local) storage are configured for processing the same type of graphics texture data that is to be processed, but at different level(s) of detail, it should still be possible to process the particular instance of graphics texture data using the neural network(s) for which the relevant data (structures) are currently available in the (local) storage, this just may not provide as effective decompression (i.e. the decompression may be more ‘lossy’). However, it if can be determined that the particular instance of graphics texture data being processed will anyway have relatively lower (visual) impact, any such loss of quality may be acceptable, as this is unlikely to be readily perceptible to users.

Thus, in embodiments, when a particular instance of compressed graphics texture data is to be processed into an uncompressed format for use by the graphics processor by executing one or more neural network(s), it is first checked whether required data or data structures for a corresponding set of neural network(s) that is (specifically) configured for processing the particular instance of compressed graphics texture data are already available in the storage of the texture data processing system. If the required data or data structures for a corresponding set of neural network(s) that is (specifically) configured for processing the particular instance of compressed graphics texture data are already available in the (local) storage, these can accordingly then be used to process the texture data.

On the other hand, when it is determined that some or all of the required data or data structures for the corresponding set of neural network(s) that is (specifically) configured for processing the particular instance of compressed graphics texture data are not already available in the (local) storage of the texture data processing system, rather than always fetching in the required data (structures) (and stalling processing to do so), it is first determined whether the particular instance of graphics texture data should nonetheless be processed using some or all of the data (structures) that are already available in the (local) storage of the texture data processing system (and hence in embodiments avoiding fetching at least some of the data (structures) that may be required for the corresponding set of neural network(s) that is (specifically) configured for processing the particular instance of compressed graphics texture data).

That is, if it can be determined that it is acceptable to re-use some or all of the data (structures) that are already available in the (local) storage of the texture data processing system to perform the desired graphics texture data processing, e.g. since doing this will not significantly impact the overall (visual) acceptability of the render output being generated, this is in embodiments done, thus avoiding having to always fetch in the new (‘correct’) data (structures) for processing the particular instance of graphics texture data.

Again, this is in embodiments done based on expected (visual) impact of the particular instance of graphics texture data, which again is in embodiments determined based on the information gathered by the initial processing pass. Thus, the operation of the texture data processing system when performing the desired neural network based texture processing (decompression) during a further processing pass s controlled based on such information gathered by the corresponding initial processing pass.

More generally, other suitable control of how the texture data processing is used to obtain and process texture data may be performed based on the information gathered by the initial processing pass.

For instance, in the examples described above, the particular control of how the graphics texture data that is to be applied to one or more sampling positions within the render output during the further processing pass is obtained from the texture data processing system involves determining whether or not it is acceptable to re-use certain data or data structures are already available locally to the graphics processor even if that data may not correspond specifically to the graphics texture data and level(s) of detail that is being requested.

Other arrangements would however be possible for controlling how the graphics texture data is applied to (try to) reduce processing burden and/or memory bandwidth when it is possible to do so.

For instance, in one example, rather than determining an appropriate (specified) level of detail for the graphics texture data, and causing graphics texture data at the appropriate (specified) level of detail to be returned, the graphics processor could be caused to simply always return a lower (e.g. the lowest) quality version of the graphics texture data when it is determined that it is acceptable to do so (e.g. at sampling positions where it is determined that the graphics texture data will have lower (visual) impact), regardless of what level(s) of detail would be determined to be used. This approach may then help to reduce processing burden by (directly) reducing graphics texture data quality where it can be determined from the initial processing pass that it is acceptable to do so.

As another example, one or more decompression parameters may be controlled based on the determined (visual) impact.

Various other arrangements would be possible in this regard.

Thus, in general, the technology described herein is operable and configured to control how graphics texture data that is to be applied to one or more sampling positions within the render output during the further processing pass is obtained from the texture data processing system (e.g. by controlling what is returned in response to graphics texturing requests) and this control is performed (at least in part) based on the set of information generated from the processing of the sequence of primitives by the initial processing pass.

This particular control can be performed in various ways as described above. Further, this particular control can be performed by various elements. For example, in embodiments, the control may be performed (in part) by an appropriate unit or circuit within the texture cache system itself but other arrangements would be possible. For example, the control may be performed (in part) by an appropriate unit or circuit within the texture mapping unit of the texture data processing system, or by any other suitable and desired unit or circuit within the graphics processor (or graphics processing system).

It will be appreciated from the above that in response to a texturing request for a particular instance of graphics texture data the texture data processing system is thus operable and configured to perform different operations when obtaining (and processing) the requested graphics texture data.

For instance, in the examples described above, there is generally a first texture data obtaining operation that can be performed and that effectively obtains and processes the requested texture data in ‘full’ so that the particular requested texture data (at the specified level(s) of detail, etc.) is always returned to the graphics processor in response to the texturing request. The first texture data obtaining operation may thus be considered as a “default” operation, e.g. that is normally performed. However, according to the technology described herein, the texture data processing system is in embodiments also selectively operable to obtain (and process) the requested graphics texture data ‘differently’ to this first, default operation.

In particular, as discussed above, the ‘different’ operation may omit or change some or all of the processing according to the first, default texture data obtaining operation, in particular to (try to) re-use data or data structures that are already available in (more) local storage when it can be determined that it is acceptable or appropriate to do so (which may mean that the texture data that is returned does not correspond exactly to what was requested, but in embodiments reduces the processing burden and/or memory bandwidth associated with the graphics texturing operations).

Being able to selectively handle texturing requests in this ‘different’ manner can thus provide an overall improved graphics processing operation.

For instance, a graphics processor could be configured to always process texturing requests in the same particular manner, e.g. by always returning the requested graphics texture data at the specified level(s) of detail, and always ensuring to use the particular neural network(s) that are configured for the requested graphics texture data at the specified level(s) of detail, etc.

Thus, a (more traditional) graphics processor may only be operable and configured to process graphics texture data in one particular manner (e.g. according to a first, default texture data obtaining operation), such that any and all graphics texture data that is required is then obtained and processed in that same particular manner, i.e. by issuing an appropriate texturing request, which then causes a certain set of standard processing operations to be performed to service that texturing request.

The present Applicants recognise, however, that it may be beneficial for a graphics processing system to be operable to selectively process (at least some) graphics texture data differently, e.g., and in particular, such that rather than always obtaining and processing graphics texture data in the same particular manner in response to a texturing request, the graphics processor is also operable to selectively perform different processing in response to a texturing request, in particular to try to reduce memory bandwidth and/or processing burden, when it is appropriate or acceptable to do so (e.g., and in embodiments, when it can be determined that doing this will have minimal or no impact on the overall (visual) acceptability of the render output that is being generated).

In this way, appropriate control can then be (and in the technology described herein is) performed during the further processing pass in order to control how the graphics texture data is obtained from the texture data processing system, and in particular to allow the texture data processing system to selectively override some or all of its ‘standard’ (first, default) texture data obtaining operation to obtain and process graphics texture data in a different manner (i.e. according to a second, different texture data obtaining operation).

Thus, the texture data processing system may in effect have a set of different operations available for obtaining (and processing) graphics texture data, and the particular control according to the technology described herein may involve selecting between the different available processing operations.

The different operation (or operations) available to the graphics processor may generally differ from each other (or from the normal, default operation) in any suitable and desired manner but in general the different processing should be such that the overall processing burden and/or bandwidth associated with the different processing operation is reduced compared to the normal, default operation.

For example, as mentioned above, the first, default texture data obtaining operation is in embodiments a ‘default’ processing operation that is in embodiments operable to obtain the graphics texture data in the (exact) format specified by the texturing request, e.g. as desired or specified by the application that requires the graphics processing.

Thus, the first, default texture data obtaining operation in embodiments involves determining a level or levels of detail at which the graphics texture is to be applied to a set of one or more sampling positions, obtaining the particular requested graphics texture data at the specified level(s) of detail, including processing (e.g. decompressing) the graphics texture data, as needed, for use by the graphics processor, and then returning the particular requested graphics texture data at the specified level(s) of detail (so that it can then be applied appropriately to the relevant sampling position(s)).

In contrast, the second, different texture data obtaining operation may, e.g., and in embodiments does, omit or change some or all of these steps to reduce the memory bandwidth and/or processing burden associated with the graphics texture data processing. Thus, the second, different graphics texture data obtaining operation may, e.g., be, and in embodiments is, a ‘reduced’ version of the first (default) graphics texture data processing operation.

Various options are contemplated in this regard for performing the different processing, e.g. as discussed above. For example, in embodiments, the second, different graphics texture data obtaining operation is operable to re-use data or data structures already available (more) locally to the graphics processor (even if these do not specifically correspond to the instance of graphics texture data that was requested), rather than always fetching in new data or data structures if the corresponding data or data structures for the particular instance of graphics texture data being requested are not locally available.

According to embodiments, therefore, the graphics processing system of the technology described herein is selectively operable to process texturing requests during the further processing pass in multiple, different ways, e.g., and in particular, to (try to) reduce memory bandwidth and/or processing burden when it is acceptable and appropriate to do so, and wherein the identification of instances where different processing of the graphics texture data can (and should) be performed is determined from the set of information gathered by the initial processing pass.

The controlling how texture data is obtained may thus comprise:
determining, based on the set of information generated from the processing of the sequence of primitives by the initial processing pass, a respective texture data
obtaining operation according to which the texture data should be obtained; and then obtaining the texture data according to the determined texture data obtaining operation.

Thus, the graphics processor (and method) according to the technology described herein in embodiments tries to identify instances where it is acceptable to obtain some of the graphics texture data in a different manner from the first, default texture data obtaining operation (e.g., and in particular, because it is acceptable to process the graphics texture data at a different quality than may be done according to the first, default texture data obtaining operation), and the texture data processing system then performs suitable different processing.

In this way, the overall processing burden and/or bandwidth associated with the graphics texturing operations that are performed during the further processing pass can be (and in embodiments is) reduced.

As mentioned above, the particular control according to the technology described herein, e.g., and in embodiments, including the identification of instances where it is acceptable to process some of the graphics texture data differently, is performed (at least in part) performed based on a set of information gathered by the initial processing pass that is indicative of which graphics texture data is to be applied at which sampling positions.

In particular, as will be explained further below, the set of information gathered by the initial processing pass is usable to identify which graphics texture data is to be applied at which sampling positions which knowledge can be (and in embodiments is) in turn used to identify instances where it may be acceptable to process some of the graphics texture data differently, e.g. to (try to) reduce memory bandwidth and/or processing burden.

For example, and in embodiments, as mentioned above, the particular control involves performing different processing for instances of graphics texture data that is to be applied to sampling positions where the graphics texture data can be determined to have relatively lower (visual) impact on the overall render output being generated.

In this respect, in some cases it may be desired that the graphics processor should always process graphics texture data in the same way, e.g., according to its normal, default operation, e.g. by always returning the requested graphics texture data to the graphics processor at the appropriate (specified) level (or levels) of detail. As mentioned above, the appropriate level(s) of detail may be specified by the application, but it could also be determined dynamically on a per-region basis based on screen space co-ordinates of adjacent fragments, optionally with an application specified bias.

In some cases it may even be desired that the graphics processor always processes graphics texture data at the highest (available) quality level, and so this may be specified by the application. This may be appropriate for example where the graphics processor is being used for general-purpose computing applications, such as scientific computing, or other general-purpose computational tasks where higher precision is desired.

In such cases, the particular control according to the technology described herein may therefore be, and in embodiments can be, (selectively) disabled.

For many graphics-related workloads, however, it is typically not necessary to render an entire render output (e.g. image) at a specified quality, especially as the user may not be able to readily perceive slight differences in quality across the output (image). For example, in many (graphics) applications it is acceptable to reduce quality (at least) in certain regions to thereby reduce the rendering workload, especially as this may anyway not be readily perceptible to the user.

(In this regard, a technique that may be used to help facilitate the generation of frames for display at an appropriate rate, particularly in “extended reality” (XR) display systems, is so-called “foveated” or “variable resolution” rendering. Variable resolution (“foveated”) rendering is a rendering technique where one or more parts of a frame (image) to be displayed are rendered at a higher resolution, but one or more other parts of the frame are rendered at a lower resolution. This is based on the fact that the area of the frame that the user is looking at directly may need to be rendered at a higher resolution for visual acceptability, while the peripheral area of the frame that the user is not directly looking at can be rendered at a lower resolution whilst still appearing visually acceptable. This can then be used to reduce the rendering burden on the graphics processor that is producing the frames by rendering the peripheral area at a lower resolution, rather than rendering the entire frame being displayed at the highest required (“foveal”) resolution.

Variable resolution rendering may more traditionally be carried out by identifying one or more “fixation points” where higher resolution areas of the frame will be rendered, with the areas further away from the fixation point(s) being rendered with a lower resolution. When performing such variable resolution rendering, the locations of the highest resolution areas of the frame (e.g. the fixation point(s)) may be determined in any suitable and desired manner. For example, some form of head tracking or eye tracking (head pose tracking) may be used to try to identify where the user is looking at the image, so as to identify the area of the frame that should be rendered with the highest resolution. Or, it may be assumed that the user will be looking at the (e.g.) central part of the image. Various arrangements are possible in this regard.)

The present Applicants recognise however that further improvements can be made in this regard.

In particular, by introducing the initial processing pass of the technology described herein, the processing of the sequence of primitives by such initial processing pass generates a set of information that is usable to identify which graphics texture data is to be applied during the further processing pass at which sampling positions within the render output.

As discussed above, this set of information can then be (and is) used to control how graphics texture data that is to be applied to sampling positions within the render output is obtained (i.e. to control the operation of the texture data processing system), in particular by allowing a determination of which instances of graphics texture data (at which sampling positions) has a relatively lower (visual) impact on the overall render output that is being generated.

In this respect, the present Applicants recognise that controlling how the graphics texture data is obtained based on (directly) gathered knowledge of which graphics texture data is to be applied at which sampling positions in embodiments allows for a more direct control over the operation of the texture data processing system. This can therefore potentially (and in embodiments) allow further opportunities for reducing the memory bandwidth and/or processing burden associated with the graphics texturing operations.

For instance, and in embodiments, as mentioned above, the texture data processing system is operable to identify, based on the knowledge of which graphics textures are visible at which sampling positions, certain instances of graphics texture data where it is acceptable to obtain and process the graphics texture data in a ‘different’ manner, e.g. to reduce the memory bandwidth and/or processing burden associated with the graphics texturing operations, and this particular control can be (and is) done based on (directly) gathered knowledge of which graphics texture data is to be applied at the respective sampling positions within the render output (e.g. rather than based on (expected) “fixation points”) in such a way that the overall image (in embodiments) still maintains a desired level of visual acceptability.

This can then provide various improvements.

For example, as described above, the determination of whether it is acceptable to use the graphics texture and/or neural network data (structures) that are already locally available to the graphics processor (even when they do not specifically correspond to the particular instance of graphics texture data being requested (such that the first, default operation would cause new data (structures) to be fetched in)), is in embodiments performed based on the (expected) (visual) “impact” of the graphics texture data in question.

There are various ways to determine the (visual) “impact” of a particular instance of graphics texture data but according to the technology described herein this can be (and is) done based on the information generated by the initial processing pass as to which graphics textures are visible at which sampling positions within the render output.

For example, it can be determined from the set of information generated by the initial processing pass whether a particular instance of graphics texture is only visible in certain peripheral regions of the render output. As discussed above, if a particular graphics texture is only visible in certain peripheral regions of the render output, this may then mean that it is acceptable to obtain that graphics texture data in the different manner, in particular since any variation (e.g. reduction) in quality in peripheral regions is unlikely to be readily perceptible to users.

That is, if a particular instance of graphics texture data is only being applied to sampling positions in peripheral regions of the render output, it does not matter if that instance of graphics texture data is obtained at a different quality to what has been determined (and specified), since any change in quality should not impact the overall visual acceptability of the image for the user (as the user's gaze will not typically be focussed on those regions).

Thus, in some embodiments, the determining whether a particular instance of graphics texture data has relatively lower expected (visual) impact (and hence can and should be processed ‘differently’) includes identifying from the set of information generated by the initial processing pass that the instance of graphics texture data is (only) to be applied at sampling positions that are outside of an expected foveal region of the render output.

As another example, however, even if a particular instance of graphics texture is visible within the expected foveal region, if that graphics texture is only visible at a relatively smaller number of sampling positions, it may also be acceptable to process that graphics texture data at a reduced (lower) quality, as in that case even though the graphics texture is within the expected foveal region, the visual impact of the graphics texture is relatively lower, so that the user again is still not likely to perceive any reduction in texture quality at those particular sampling positions for which the graphics texture is visible.

Thus, in some embodiments, the determining whether an instance of graphics texture data will have relatively lower (visual) impact includes identifying from the set of information generated by the initial processing pass that the instance of graphics texture data is (only) to be applied at sampling positions that are outside of an expected foveal region of the render output that the instance of graphics texture data is (only) to be applied at relatively few sampling positions within the render output, e.g. fewer than a threshold number of sampling positions.

Thus, in embodiments, the determining whether an instance of graphics texture data will have relatively lower (visual) impact (that may then be used to control how the graphics texture data is applied) is done based on the graphics texture data in question only being visible at a relatively smaller number of sampling positions. This can be determined with respect to a suitable threshold number of sampling positions. Thus, in embodiments, when it is determined based on the set of information generated by the initial processing pass that a particular graphics texture is visible at fewer than a certain threshold number of sampling positions, this means that the associated graphics texture data can then be (and so in embodiments is) then applied differently, e.g. as discussed above.

In that case, the threshold number of sampling positions may be set as desired, e.g. depending on the desired overall image quality.

As another example, rather than a threshold number of sampling positions as such, the determining whether an instance of graphics texture data will have relatively lower (visual) impact may be made based on a threshold number of adjacent sampling positions. That is, if the graphics texture only appears in isolated regions of the render output, this may again indicate the graphics texture has relatively lower (visual) impact and so the graphics texture data may be applied to (the sampling positions within) those regions at different quality without this being readily perceptible to the user.

Other suitable criteria for assessing the (visual) impact of graphics texture data that is to be applied to a particular set of one or more sampling positions, may for example include where the primitive that is visible at the sampling position(s) at which the graphics texture is to be applied is partially transparent and/or covered by a partially transparent fragment. Again, in those cases, the graphics texture may therefore have relatively lower (visual) impact.

Thus, various heuristics may be used to determine whether (and when) an instance of graphics texture data has relatively lower (visual) impact, and hence whether the graphics texture data can be applied in a different manner (to the default operation) without significantly reducing the visual acceptability of the overall render output.

For example, suitable heuristics to determine that a particular instance of graphics texture has relatively lower expected (visual) impact may include one or more of:
the particular instance of graphics texture data being visible (or primarily visible) only at sampling positions outside an expected foveal region of the render output (i.e. peripheral regions of the render output);
the particular instance of graphics texture data being visible at fewer than a (certain) threshold number of sampling positions;
the particular instance of graphics texture data being visible at fewer than a (certain) threshold number of adjacent sampling positions;
the primitive that is visible at the sampling position or positions to which the particular instance of graphics texture data is to be applied being partially transparent; and
the sampling position or positions to which the particular instance of graphics texture data is to be applied being covered by another partially transparent primitive,
but various other suitable heuristics could also be used, as desired.

These heuristics may be applied separately or in combination. For instance, these heuristics could be applied cumulatively, e.g. so that an instance of graphics texture data is (only) determined to have lower (visual) impact if it is both outside the (expected) foveal region and visible at a relatively smaller number of sampling positions.

As another example, the determination may be based on identifying graphics texture data that is (only) to be applied at a relatively smaller number of sampling positions within the render output, e.g. using a suitable threshold, as described above, but different threshold numbers of sampling positions may be used for different regions of the render output. For instance, the threshold number of sampling positions that is used for graphics textures that are visible at sampling positions within the foveal region may be lower than the threshold number of sampling positions that is used for graphics textures that are visible at sampling positions for (peripheral) regions outside the foveal region.

In this respect, it will also be appreciated that a particular graphics texture may have visibility at sampling positions both within the foveal region and outside of the foveal region, and in embodiments that graphics texture data is only obtained and processed once during the further processing pass (for instance, as will be mentioned below, in embodiments, the further processing pass is controlled and performed such that any sampling positions where the (same) graphics texture is visible are processed relatively closer together, e.g. in consecutive order, so that the same graphics texture data, once loaded in, can be used for the processing of each of those sampling positions). In that case, the determination as to whether an instance of graphics texture data can and should be applied in the different manner (e.g. because the graphics texture has lower visual impact) may take into account weighted contributions from the different regions. For instance, if a particular graphics texture is visible at sampling positions both within the foveal region and outside of the foveal region, but only has very limited visibility in the foveal region, it may still be acceptable to process the graphics texture in the different manner.

Various arrangements would be possible in this regard and in general the determination whether (or not) particular instance of graphics texture data has relatively lower (visual) impact) can be done based on any suitable and desired heuristics that may be applied based on the set of information generated by the first processing pass.

As mentioned above, the particular control according to the technology described herein controls how graphics texture data is obtained from the texture data processing system in response to the graphics processor issuing a texturing request for a particular instance of graphics texture data (and in embodiments controls the operation of the texture data processing system when obtaining/processing that particular instance of graphics texture data).

Thus, rather than always processing texturing requests in the same way, the texture data processing system may be selectively operable to perform different processing in response to certain texturing requests. The different processing that the texture data processing system may perform in response to texturing requests can include any suitable and desired different processing, but the effect of the different processing is in embodiments that the memory bandwidth and/or processing burden, can be (and is) reduced in some way.

There are various ways this could be achieved.

For instance, in some embodiments, when it is determined that an instance of graphics texture data has relatively lower (visual) impact, the texture data processing system may be forced to return a lower resolution version of the requested graphics texture data, independently of the level(s) of detail that is specified in the texturing request.

For instance, as mentioned above, a texturing request may specify a desired level (or levels) of detail at which a particular instance of graphics texture data should be obtained, and this can cause the appropriate mipmap level or levels to be fetched. Thus, obtaining different resolution versions of the graphics texture data may comprise fetching different mipmap levels. The first, default operation may therefore serve to return the requested graphics texture data at the specified level(s) of detail. In contrast, the second, different operation may cause a lower (e.g. the lowest) resolution version of the graphics texture data to be returned, regardless of what level(s) of detail are specified in the texturing request. This can then directly reduce the processing burden, and potentially also memory bandwidth.

This approach may however still involve relatively higher memory bandwidth especially if different resolution versions of the same graphics texture need to be alternately fetched for different texturing requests. Thus, in embodiments, the particular control according to the technology described herein in embodiments attempts to re-use data or data structures that are already available locally to the graphics processor, when it is determined that it is appropriate or acceptable to do so.

For example, if the same type of graphics texture data that is being requested is available locally in the texture cache system but at a level of detail other than the level(s) of detail specified in the texturing request, it may still be acceptable to return the graphics texture data at the other level(s) of detail provided that this will not significantly impact the overall (visual) acceptability of the render output. In particular, if the (same) graphics texture data is stored at a higher level of detail, it should generally be acceptable to return this in response to the texturing request, as this should not impact the overall (visual) acceptability of the render output. However, even if the (same) graphics texture data is stored at a lower level of detail, it may still be acceptable to return this in response to the texturing request, so long as it can be determined that doing so will not significantly impact the overall (visual) acceptability of the render output, e.g. as discussed above.

It would also be possible, in other examples, to tailor the decompression parameters, e.g. to perform more lossy decompression, which can again reduce the amount of data to be processed.

A particular example of this would be when the graphics processing system supports neural network based texture processing (decompression).

For instance, there may be plural different neural networks that can be used for processing different types of graphics texture (e.g. with different neural networks being configured, e.g. by training, to process specific types of graphics texture).

The graphics processing system may thus comprise suitable storage that is operable and configured to store suitable neural network data or data structures for the different neural networks (more) locally to the texture data processing system of the graphics processor. This storage may take various desired form.

When performing neural network based texture processing (decompression), the first, default texture data processing operation may thus comprise first loading in any and all relevant data and data structures for the appropriate set of neural network(s) that is specifically configured for the particular instance of graphics texture data that is to be processed (if the appropriate neural network data or data structures are not already present in such storage (e.g. since they were also used for a previous neural network based texture processing operation)), so that the neural network texture processing can then be performed accordingly using the appropriate configured neural network(s).

On the other hand, when it is determined that a particular instance of graphics texture data can be obtained and processed by the texture data processing system in a ‘different’ manner, e.g. because the particular instance of graphics texture data has a lower expected (visual) impact, it may acceptable to process the graphics texture data using all or part of the neural network(s) for which the relevant data (structures) are already available in the storage (regardless of whether those neural network(s) (data (structures)) are specifically configured for processing the particular instance of graphics texture data in question).

Various arrangements would be possible here.

For example, the particular control that is performed in the event that it is determined that it is acceptable to process a particular instance of graphics texture data ‘differently’ may be to simply use whichever neural network(s) are currently available, regardless of whether they are configured even for that general type of graphics texture. In this regard, although the specific ‘correct’ set of neural network(s) should give the best quality decompression performance, it will be appreciated that neural networks are good at generalising and so even the ‘incorrect’ neural network(s) may still be able to produce reasonable (but lossier) results. This may be particularly so when the different neural networks share similar underlying data (structures) (e.g. where transfer learning is used).

In embodiments, however, the particular control to process the graphics texture data using all or part of the neural network(s) for which the relevant data (structures) are already available in the storage (regardless of whether those neural network(s) (data (structures)) are specifically configured for processing the particular instance of graphics texture data in question) is (only) done when those neural network(s) are sufficiently similar to the ‘correct’ neural network(s). For instance, this might be the case where the neural network(s) are configured to process the same type of graphics texture but are configured to process different level(s) of detail than the level(s) of detail that are required for the particular instance of graphics texture data processing.

In this respect the particular control could also be to fetch in only some of the relevant data (structures) (but to re-use other data (structures) that are currently available). Various arrangements would be possible in this regard.

The technology described herein may therefore provide various benefits compared to other possible approaches.

Subject to the particular requirements of the technology described herein, the rendering process that is performed for a sequence of primitives may be performed in any suitable and desired manner.

For example, as mentioned above, an initial processing pass is in embodiments performed to determine which particular primitives in the sequence of primitives are visible for which sampling positions within the render output.

In embodiments, the initial processing pass thus generates a set of “visibility” information that is usable to identify which primitives are visible at which sampling positions, and hence is usable to determine the further processing to be performed in respect of those sampling positions (which knowledge may then be (and in embodiments is) used to control the further processing pass).

The initial processing pass may thus comprise any suitable and desired steps to do this. In general, however, the initial processing pass comprises processing (e.g. rasterising) primitives into respective sets of one or more fragments and then performing one or more fragment processing operations to determine the desired visibility information. The visibility information is typically, and in embodiments, based on the fragment depth values. That is, which fragment will be visible at a particular sampling position will typically be, and is in embodiments, determined (at least in part) by which fragment is front-most in the scene (i.e. has the closest depth value).

The initial processing pass thus in embodiments comprises (early) depth testing the fragments to update a depth buffer for the render output. The depth buffer stores a set of per-sampling position depth values for the render output. Thus, in embodiments, the initial processing pass comprises testing a (the current) fragment's depth value against a corresponding depth value stored in a depth (Z) buffer. If the fragment survives the depth testing, the depth buffer is in embodiments then updated to include the current fragment's depth value, and so on, until all of the fragments for the primitives have been processed. The resulting depth buffer at the end of the initial processing pass therefore represents the depth buffer for the sequence of primitives as a whole.

In some embodiments the initial processing pass thus comprises processing (e.g. rasterising) the primitives into respective sets of one or more fragments and then depth testing the fragments to update a depth buffer. The depth buffer is in embodiments used to generate a set of primitive identifying information, as will be explained further below, which set of primitive identifying information is written to suitable storage at the end of the initial processing pass.

The set of primitive identifying information could be written out to external memory but in embodiments the set of primitive identifying information is written to local storage, e.g. a dedicated portion of RAM that has been allocated for the current rendering operation (e.g. for a tile that is being rendered), and which local storage can thus be overwritten once the current rendering operation is complete. For example, in a tile-based rendering system, the dedicated portion of RAM may be a (portion of a) tile buffer. Various arrangements would however be possible in this regard.

In some embodiments the fragment processing for the initial processing pass finishes at this point, i.e. after writing out the set of primitive identifying information (and any other buffers that may desirably be written out). Thus, in embodiments, after the (early) depth testing is performed, and the depth buffer updated accordingly (as needed), the fragment processing for the initial processing pass is finished, and the fragments are not processed further by the initial processing pass (although the initial processing pass may continue, e.g., to populate the set of primitive identifying information, before the initial processing pass itself is complete).

Thus, in some embodiments, the initial processing pass does not, e.g., execute a fragment shader to render the fragments (e.g. to determine colour values for the final render output). In other embodiments a (partial) fragment shader may however be executed. For example, this may be appropriate to handle primitives where a fragment shader is needed to determine the fragment's depth value and/or coverage. In that case, final (colour) output is in embodiments still disabled and fragment shader is run far enough to update depth buffer, but the fragments are in embodiments not rendered in full to avoid having to calculate the final rendered output data at this stage (since it may be overwritten later). Various arrangements would be possible in this regard.

After the initial processing pass is finished, e.g., and a suitable set of visibility information has been determined, a corresponding further processing pass is performed to generate the final render output. The result of the further processing pass is thus to generate the final render output, e.g. by performing fragment shading to generate a set of rendered output values for the respective sampling positions within the render output (e.g. to determine the appearance (e.g. colour) that the associated sampling positions should have in the final render output).

The processing that is performed during the further processing pass in respect of a particular sampling position may thus, and in embodiments does, comprise determining which particular primitive in the sequence of primitives is visible at that sampling position, converting the primitive into a respective fragment associated with that sampling position, and then performing one or more further fragment processing operations including, e.g., executing a fragment shader and applying appropriate graphics texture data in order to determine the corresponding (rendered) output value for that sampling position.

Thus, in general, one or more of the same primitives may be (and in embodiments are) processed in both processing passes, but the same primitive(s) undergo different processing in the respective processing passes. For example, in embodiments, the initial processing pass involves at least processing (e.g. rasterising) the primitives into fragments and performing fragment depth testing to generate a set of “visibility” information for the sequence of primitives. The initial processing pass does not however write out, and in embodiments does not generate either, any final rendered output (e.g. colour) values. This is then done by the further processing pass which generates the respective (rendered) output values for the respective sampling positions within the render output being generated.

Thus, the further processing pass, for each sampling position for which an output value is to be generated, in embodiments generates the respective (rendered) output value by determining the particular primitive that is visible at that sampling position, and then rendering the primitive for that sampling position, e.g., including executing any fragment shader(s) and applying graphics texture data, as appropriate, to generate and output the desired (e.g. colour) value for that sampling position.

The determining during the further processing pass which particular primitive in the sequence of primitives is visible at a particular sampling position is in embodiments done using the information generated by the initial processing pass. For example, as will be explained further below, the initial processing pass in embodiments generates a set of primitive identifying information indicating which particular primitive is visible for each sampling position within the render output. This information can therefore be used to quickly identify during the further processing pass which particular primitives need to be processed for which sampling positions. For example, for each sampling position, the sequence of primitives can be quickly iterated over to identify which primitive matches the corresponding entry in the set of primitive identifying information. Various arrangements would however be possible in this regard.

It will be appreciated that the processing that is performed in either the initial processing pass or further processing pass may in general also comprise any other suitable processing steps (stages) that may be desired.

As mentioned above, the initial processing pass in embodiments generates a set of “visibility” information for the sequence of primitives. The set of “visibility” information that is generated from the processing of primitives by the initial processing pass according to the technology described herein may generally take any suitable and desired form.

In an embodiment, however, as alluded to above, the initial processing pass generates a set of “primitive identifying” information that stores—for respective sampling positions within the render output-respective primitive identifiers identifying which particular primitives in the sequence of primitives should be processed further for which sampling positions within the render output. The primitive identifier that is stored for a respective sampling position thus indicates the particular primitive in the sequence of primitives that is visible at that sampling position, and hence which should be subsequently be processed further for the sampling position to generate the respective (rendered) output value. In embodiments, a single primitive is identified to be processed further for a (and each) respective sampling position (and in some cases the set of primitive identifying information is configured to only be able to identify a single primitive). In some embodiments, multiple primitives may be identified to be processed further for a (and each) respective sampling position, and the set of primitive identifying information can be configured appropriately to facilitate this. For example, if the sequence of primitives includes non-opaque primitives, and a non-opaque primitive is the foremost primitive for a particular sampling position, it may be appropriate to store multiple (partially visible) primitives in respect of that sampling position, optionally also with an indication that alpha blending is to be performed. Various arrangements would be possible in this regard.

The initial processing pass thus in embodiments generates a set of primitive identifying information that indicates, by reference to the stored primitive identifiers, which primitives are visible at which sampling positions (and hence which primitives should subsequently be processed further for which of the sampling positions).

The set of primitive identifying information thus in embodiments contains a plurality of entries corresponding to the sampling positions within the render output and which entries are able to store for the respective sampling positions within the render output a respective primitive identifier indicating which primitive (if any) should be further processed for the corresponding sample point(s).

Any suitable primitive identifiers can be used in this respect so long as different primitives in the sequence of primitives can suitably be identified. There may also be a suitable ‘null’ identifier that can be used to indicate that nothing is visible at a particular sampling position (and hence further processing of that sampling position can be effectively skipped). Various arrangements would be possible in this regard.

There may in general be any suitable and desired correspondence between the entries in the set of primitive identifying information and the sampling positions within the render output. For example, the set of primitive identifying information should be (and in embodiments is) able to store a primitive identifier in respect of each sampling position within the render output. That is, the set of primitive identifying information in embodiments stores for each sampling position within the render output a respective primitive identifier indicating the primitive (if any) that should be processed for that sampling position.

Thus, in some embodiments, there may be a direct one-to-one correspondence between the number of entries in the set of primitive identifying information and the number of sampling positions within the render output, such that each sampling position has a corresponding (unique) entry in the set of primitive identifying information for storing a respective primitive identifier for that particular sampling position.

However, it would also be possible to arrange the set of primitive identifying information in a “hierarchical” manner, for example, such that the set of primitive identifying information (also) comprises entries corresponding to groups of plural sampling positions within the render output, and in some embodiments this is done. In that case, the set of primitive identifying information may typically contain a greater number of entries than there are sampling positions, e.g., and in embodiments, such that the set of primitive identifying information contains respective entries for each individual sampling position, but also contains one or more entries that apply to groups of sampling positions, e.g., and in embodiments, based on a hierarchical division of the render output.

For example, in addition to the entries corresponding to individual sampling positions, there may also be entries corresponding to groups (or “patches”) of, e.g., 4, 16, 32, 64, etc., sampling positions. Further, an entry may be provided corresponding to the entire render output.

Various arrangements would be possible in this regard.

The set of primitive identifying information thus indicates which primitives are visible at which sampling positions.

It will be appreciated in that regard that a particular primitive (vertex) will typically have defined for it a respective graphics texture that may be applied to sampling positions where that primitive is visible. Further, that same graphics texture may also be associated with other primitives in the sequence of primitives. Thus, from the set of primitive identifying information generated by the initial processing pass, it can accordingly be identified which graphics textures are to be applied at which sampling positions within the render output.

In embodiments, therefore, the set of primitive identifying information generated from the initial processing pass is further processed to determine a corresponding set of “texture identifying” information indicating which graphics textures are to be applied at which sampling positions within the render output. This may be beneficial since the texture identifying information directly indicates which graphics textures are to be applied at which sampling positions and so when the control is performed to try to reduce texturing bandwidth, this may facilitate a simpler control operation.

The respective entries of the set of “texture identifying” information may thus generally indicate, for respective sampling positions, which graphics texture is to be applied when processing that sampling position. This can be done in various suitable ways as desired. For example, in some embodiments, the respective entries of the set of “texture identifying” information may store texture identifiers per se (i.e. that directly indicate a graphics texture that is to be applied at the respective sampling position). Other arrangements would however be possible. For example, respective entries of the set of “texture identifying” information could also or alternatively identify a class of textures that can be processed using the same neural network data structures, for instance. As another example, the shader program (e.g. pointer) could be used as an identifier of the graphics texture that is to be applied. For instance, a shader program may be compiled with the texture (identifier) hardcoded into the shader program, and in that case the shader program identifier also serves as texture identifying information.

Subject to the particularly requirements of the technology described herein, this set of “texture identifying” information can generally be arranged and stored in any suitable fashion, including hierarchical arrangements, e.g. similarly to the set of primitive identifying information.

Various arrangements would be possible in this regard.

In embodiments, therefore, a set of primitive identifying information generated from the initial processing pass is iterated over to generate a corresponding set of texture identifying information (and the particular control according to the technology described herein is then performed based on the set of texture identifying information).

Other arrangements would however be possible.

For example, it would also be possible for the initial processing pass to directly generate a set of texture identifying information (i.e. rather than adding primitive identifiers to a set of primitive identifying information that is populated during the first, pre-pass operation, and then potentially iterating over the set of primitive identifying information to generate a set of texture identifying information, the initial processing pass could directly populate a set of texture identifying information). Thus, a benefit of generating and storing the set of primitive identifying information is that this may also be used during the further processing pass (e.g. to accelerate determining which primitives are visible at which sampling positions). It is also relatively straightforward to then generate the texture identifying information from such primitive identifying information. However, the particular control of the technology described herein may not necessarily use the set of primitive identifying information, and could in principle be performed using only the set of texture identifying information, and so in some cases it may be desired to generate this directly.

As alluded to above, the further processing pass may be, and generally is, controlled based on the information generated by the initial processing pass. Various types of control can be performed in this respect.

Thus, the particular control according to the technology described herein controls how the graphics texture data is processed during the further processing pass based on the information that is generated by the initial processing pass, in particular by using the initial processing pass to identify sampling positions where the applied graphics texture data will have relatively lower (visual) impact, and to allow the graphics texture data that is to be applied to those sampling positions to be processed differently, e.g. as described above.

In embodiments, as described above, the information that is generated by the initial processing pass is used to control the operation of the texture data processing system when handling texturing requests issued by the graphics processor (programmable execution unit). Thus, after an initial processing pass has been performed to determine such information, this may then be suitably signalled to the texture data processing system for controlling the operation of the texture data processing system during the corresponding further processing pass.

Other arrangements would, however, be possible for controlling how the texture data is obtained and processed based on the initial processing pass. For example, in embodiments, rather than controlling the operation of the texture data processing system when processing a texturing request based on such information generated by the initial processing pass, the graphics processor (programmable execution unit) may be operable and configured to control how texturing requests are generated based on such information generated by the initial processing pass.

In that respect, the information generated by the initial processing pass as to the expected (visual) impact of particular instances of graphics texture data at particular sampling positions may thus be used by the (fragment) shader program to control the generation and issuing of the corresponding texturing request. In that case, the (fragment) shader program may, for example, take the information generated by the initial processing pass as to the expected (visual) impact of particular instances of graphics texture data at particular sampling positions as input to determine whether to request texture data at a particular specified level or levels of detail or whether to try to re-use texture data already available in the texture cache. In this regard the (fragment) shader program may directly determine the level or levels of detail that are specified in the texturing request based on the information generated by the initial processing pass, or the texturing request may act as the signalling to the texture data processing system to perform the different processing. Various arrangements would be possible in this regard.

Thus, in embodiments, controlling how the graphics texture data that is to be applied to one or more sampling positions within the render output during the further processing pass is obtained from the texture data processing system comprises controlling (or determining) (which) information that is included into the texturing request based on the set of information generated from the processing of the sequence of primitives by the initial processing pass.

For instance, this may involve controlling which level or levels of detail are specified in the texturing request based on the set of information generated from the processing of the sequence of primitives by the initial processing pass.

Alternatively/additionally, this may involve including signalling (e.g. a flag) into the texturing request based on such information to indicate to the texture data processing system that the texturing request should be handled ‘differently’, e.g. in the manner discussed above.

The control of the generating of the texturing requests could be performed as part of the (fragment) shader program execution, as discussed above. In yet further embodiments, the graphics processor (programmable execution unit) may perform an initial determination of how the texture data should be obtained for each sampling position in the render output. That is, rather than dynamically controlling how the texture data is obtained, the graphics processor may determine after the initial processing pass has finished a desired (e.g. optimised) manner for processing the texture data in respect of all of the sampling positions within the render output and then control the generation of texturing requests and/or the operation of the texture data processing system accordingly based on such determined desired manner for processing the texture data.

In this respect, it will be appreciated the graphics processor (and method) according to the technology described herein may generally also perform other control of the further processing pass based on the information that is generated by the initial processing pass.

For instance, in embodiments, the order in which sampling positions are processed during the further processing pass is also controlled based on information generated by the initial processing pass. Thus, when the particular control is performed to try to re-use data or data structures where it is appropriate and acceptable to do so, the order in which sampling positions are processed may also be controlled to increase instances where this can be done.

That is, the information generated by the initial processing pass can also be, and in embodiments is also, used to determine an improved (e.g. optimised) order in which sampling positions should be processed during the further processing pass, e.g., and in particular, to try to process sampling positions closer together that use the same data (structures) (and hence reduce instances of having to repeatedly fetch the same data (structures) into the graphics processor)).

Various arrangements would be possible in this regard.

Subject to the particular requirements of the technology described herein, the graphics processor may be any suitable graphics processor.

In some embodiments, the graphics processor may be operable and configured to perform immediate mode rendering. In that case, the initial and further processing passes of the technology described herein may be performed as part of the immediate mode rendering operations.

In other embodiments the graphics processor is operable and configured to perform tile-based rendering. The graphics processor may therefore have any suitable and desired processing stages and/or elements that a graphics processor may have when performing tile-based rendering.

When processing a render output in such tile-based rendering systems, an initial geometry processing (sorting) operation is performed in order to sort the geometry, which is defined in terms of a set of primitives to be processed for the render output, relative to the rendering tiles into which the render output is subdivided for rendering. The actual rendering of the tiles is then performed in a subsequent rendering operation, with the tiles in embodiments being rendered separately, e.g. one after another.

In a tile-based rendering system, the initial and further processing passes of the technology described herein may thus be performed as part of the tile rendering operations that are performed in respect of a (and each) tile, e.g., and in embodiments, in response to the graphics processor receiving a command to render a tile. That is, the initial and further processing passes are in embodiments performed within a rendering tile. The sequence of primitives that are processed in the manner described above therefore in embodiments corresponds to a sequence of primitives to be rendered for a respective rendering tile (e.g. as identified based on the initial geometry processing (sorting) operation that is performed to sort the geometry relative to the tiles).

The graphics processor of the technology described herein thus in embodiments comprises a geometry processing (sorting) circuit and a rendering circuit.

The geometry processing (sorting) operation may comprise any suitable and desired geometry processing (sorting) operation (and the geometry processing (sorting) circuit may correspondingly comprise any suitable geometry processing (sorting) circuit for supporting the desired geometry processing (sorting) operation).

For example, in some embodiments, the geometry processing (sorting) operation comprises a ‘tiling’ operation that is performed to generate a set of primitive lists indicative of the distribution of the primitives relative to the tiles that can be used to identify which primitives are to be rendered for which tiles. This can be done in any suitable manner, e.g. in the normal way for generating primitive lists, and the primitive lists may be prepared for any suitable regions of the render output. Thus, there may or may not be a one-to-one correspondence between the primitive lists and the actual rendering tiles.

In that case, once all of the geometry has been processed, the primitive lists are in embodiments then written out, e.g. to external (e.g. main) memory.

The primitive lists are then used during a subsequent rendering process (state) in order to perform the actual rendering of the individual tiles. The rendering circuit of the graphics processor thus in embodiments comprises a primitive list reading circuit that is configured to, when a tile is issued for rendering, identify using the respective primitive list or lists applying to the tile in question a sequence of primitives that should be processed for the tile.

The primitive list reading circuit is thus in embodiments configured to obtain the primitive lists, e.g. from memory, identify a sequence of primitives that should be processed for the tile and issue the identified primitives for rendering. This may be done in any suitable and desired manner, e.g. depending on the format of the primitive lists. For example, where the primitive lists apply to hierarchically arranged regions of the render output (such that there is not necessarily a one-to-one correspondence between primitive lists and tiles to be rendered and such that a given tile may be associated with multiple primitive lists) the step of identifying the sequence of primitives may comprise processing multiple primitive lists and merging primitives from the multiple primitive lists into the desired rendering order.

Other geometry processing (sorting) operations could however be performed. For example, in other embodiments, the geometry processing (sorting) operation may comprise generating a hierarchy of ‘bounding boxes’ that is indicative distribution of the primitives relative to the tiles and that can be used to identify which primitives are to be rendered for which tiles. In that case, the geometry processing (sorting) operation may comprise generating and writing out such bounding box hierarchy, and the subsequent rendering process may then use this to perform the actual rendering of the individual tiles.

Various other arrangements would be possible in this regard.

The identifying of a particular sequence of primitives to be rendered (e.g. the sequence of primitives for a particular tile) is in embodiments performed in response to a command to render a tile. The identified primitives are then issued accordingly into a rendering pipeline for further processing, which rendering pipeline includes the initial and further processing passes, as described above. In some embodiments however the sequences of primitives may be identified in advance (and, e.g., pre-fetched) of the graphics processor executing the rendering command that triggers the rendering process of the technology described herein. Various arrangements would be possible in this regard.

The technology described herein relates particularly to the rendering operations that are performed on the primitives that are identified to be processed. The rendering is in embodiments performed in a pipelined manner as a series of processing stages but with the pipeline being implemented across the two separate processing passes. Subject to the requirements of the technology described herein the rendering pipeline may in general comprise any suitable and desired processing stages that a graphics processing (rendering) pipeline may contain.

In particular the rendering according to the technology described herein in embodiments uses a rasterisation-based approach.

The rendering circuit (pipeline) of the graphics processor of the technology described herein thus generally includes a rasteriser for processing primitives into respective sets of fragments and a renderer that is configured to process (render) the resulting fragments to determine the appearance (e.g. colour) that corresponding sampling positions should have in the final render output.

The rasteriser (rasteriser circuit) can be configured to operate in any suitable and desired manner, for example as in known rasterising arrangements. It should operate to generate graphics fragments for processing in dependence upon which sampling positions (or which sets of sampling positions) of an array of sampling positions covering the area of the render output, a given primitive, etc., received by the rasteriser covers (at least in part).

The rasteriser in an embodiment is operable to generate a graphics fragment for each sampling position covered by, and/or for each set of plural sampling positions (e.g., sampling mask) found to include a sampling position that is covered by, the (and each) primitive being rasterised (and that is not otherwise culled from processing for another reason, such as by the primitive failing an early depth test). Correspondingly, each fragment generated by the rasteriser may represent (have associated with it) a single sampling position, or plural sampling positions, as desired. In an embodiment, each fragment represents a set of plural, in an embodiment a set of four (and in an embodiment a 2×2 array of), sampling positions.

The renderer (fragment processing circuit) of the graphics processor should be operable to render (shade) graphics fragments it receives to generate the desired output graphics fragment data. It may contain any suitable and desired rendering elements and may be configured in any suitable and desired manner. Thus, for example, it may comprise a fixed function rendering pipeline, including one or more fixed function rendering stages (circuits), such as texture mapping units (texture mappers), blenders, fogging units, etc., In embodiments the renderer comprises a fragment shader (a shader pipeline) (i.e. a programmable processing circuit that is operable to and that can be programmed to carry out fragment shading programs on fragments in order to render them).

The renderer (fragment processing circuit) will process the fragments it receives to then generate output rendered fragment data, which rendered fragment data is then in an embodiment written to an output buffer, such as a frame buffer, in external memory, for use (e.g. to display a frame on a display). The rendered fragment data may be written to the (external) output buffer via an intermediate buffer, such as a tile (e.g. colour) buffer (as will be the case in a tile-based graphics processing system).

As discussed above, as part of the fragment processing operations performed during the further processing pass, the graphics processor is also operable and configured to perform graphics texturing operations, i.e. to apply graphics texture data to sampling positions within the render output.

For instance, when generating a render output (e.g. an image), a graphics processor may perform texturing operations for sampling positions in the render output (image), e.g. to determine the appearance of the render output at those sampling positions. This typically (and in embodiments) involves applying a set of graphics texture data defining the texture surface (e.g. in terms of its colour components (e.g. RGB (A) or YUV values), but optionally also in terms other properties of the texture surface, such as luminance and/or light/shadow, surface normal, etc., values) to respective sampling positions within the render output (image) to determine the appearance (e.g. colour, etc.) that the sampling position(s) should have in the final render output (image).

Thus, graphics texture data, depending on the format in which it is stored and to be used, in embodiments includes a plurality of data “channels” including at least a set of colour (and optionally transparency) channels (e.g. storing the RGB (A) or YUV colour values for the texture surface in question) but optionally also including one or more other channels storing other properties of the texture surface.

As mentioned above, the graphics texture data is in embodiments stored in a memory system, which may, e.g., and in embodiments does, comprise a memory that is external to the graphics processor (e.g. main memory).

As also mentioned above, the transfer of graphics texture data from the (external) memory system in which the graphics texture data is stored into the graphics processor may be, and in embodiments is, facilitated by the use of an appropriate “texture data processing system” that may, for example, include a dedicated “texture mapping unit” of the graphics processor that is operable to receive texturing requests (requests for texture data) from a graphics processor programmable execution unit and process these texturing requests accordingly, and which texture mapping unit interfaces with a suitable texture cache system.

In order to facilitate storing graphics texture data in the memory system, the graphics texture data is in embodiments stored in the (external) memory system in a compressed format. Accordingly, when the graphics processor is performing a texturing operation, in response to the graphics processor requesting graphics texture data from the memory system, the requested graphics texture data must first be processed (i.e. decompressed) into a suitable, uncompressed format in which it can be used by the graphics processor.

Various texture compression/decompression schemes exists that are designed and optimised for compressing/decompressing graphics texture data and a graphics processor may have one or more suitable hardware circuits to support any such texture compression/decompression schemes, as desired (and in embodiments this is also the case for the graphics processor of the technology described herein). In embodiments, (at least some) graphics texture data can be (and in embodiments is) compressed using a neural network based texture compression scheme (and the graphics processor is correspondingly operable to support such neural network based texture processing).

That is, in embodiments, (at least some) graphics texture data is compressed by executing one or more neural networks that are suitably configured (e.g. trained) to compress the graphics texture data. The graphics texture data may therefore be stored in the memory system in a first, compressed format in which neural network based texture compression has been used to compress the graphics texture data. Correspondingly, when such graphics texture data that has been compressed in this way is fetched into the graphics processor from the memory system, the graphics texture data first needs to be decompressed from such (neural network) compressed format in which it is stored in the memory system into a suitable, uncompressed format for use by the graphics processor, and this decompression can be (and is) performed by executing one or more neural networks that are suitably configured (e.g. trained) to perform the required decompression of the graphics texture data into the desired, uncompressed format for use by the graphics processor.

In principle, neural network based texture decompression may also be used for processing graphics texture data that has been compressed in other ways, e.g. using traditional texture compression schemes. That is, rather than only being used to process (decompress) graphics texture data that has been compressed using a neural network based texture compression scheme, it may also be possible to configure and train a neural network to decompress graphics texture data that has been compressed in some other way. In that case, one or more neural network may be used to emulate some or all steps of a more traditional texture decompression scheme. Various arrangements would be possible in this regard.

In this respect, it will be appreciated that machine learning (e.g., and in particular, machine learning using neural networks) is typically good at ‘generalising’ data. For instance, neural networks, after having been trained on a certain body of training data, can then be used to process new (unseen) data, e.g., and in particular, to make inferences from that new data based on the underlying data distribution that was used for the model training. Thus, the present Applicants have found that by appropriate training of a neural network (or set of neural networks), the trained neural network(s) can provide highly efficient compression of graphics texture data (and, correspondingly, similar, e.g. ‘reverse’, neural network(s) can be used to provide effective decompression of graphics texture data that has been compressed in this way).

In particular, compared to traditional graphics texture data compression schemes, neural network based texture processing may often be able to provide relatively higher compression rates and/or image quality.

Neural network based texture processing may also advantageously provide increased flexibility and configurability since the neural network(s) can be suitably configured and trained to compress/decompress graphics texture data in any desired format, and so neural network based texture compression and decompression schemes can be configured to provide any desired number of channels, quality level, compression rate, etc., and then deployed appropriately to do this (whereas existing graphics texture data compression schemes are typically designed only to compress certain formats of data having a fixed number of channels, e.g. RGB (three channels: Red, Green, Blue) or RGBA (four channels: Red, Green, Blue, Alpha), such that where additional channels are desired, these additional channels may need to be stored as a separate graphics texture that has to then be fetched and decompressed separately to the graphics texture storing the colour values, which therefore requires additional memory bandwidth, etc., Storing these additional channels in this manner may also be relatively inefficient as existing graphics texture data compression schemes may not have been optimised for these additional channels, and therefore may not compress these channels particularly effectively).

This neural network based texture processing can be supported in various ways, as desired. For instance, the decompression of the graphics texture data could be done in software, e.g. by the graphics processor programmable execution unit executing suitable compute shader programs to perform the decompression. In some embodiments, however, the graphics processor may comprise a dedicated (hardware) neural network processing circuit (that is separate to the programmable execution unit of the graphics processor) and that is operable to perform the neural network processing for decompressing the compressed graphics texture data. This dedicated (hardware) neural network processing circuit may be dedicated for performing neural network based texture processing or could also be available for other (non-texture related) neural network processing.

It will be appreciated that in whichever manner the neural network based texture processing is supported, this processing in embodiments forms part of the overall processing performed by the “texture data processing system” described above (such that the particular control that is performed of how the graphics texture data is obtained may, and in some embodiments does, comprise controlling the neural network based texture processing).

Various arrangements would be possible in this regard.

The neural network processing that is performed when processing graphics texture data from the first, compressed format in which it is stored in the memory system to the second, uncompressed format for use by the graphics processor may comprise any suitable and desired processing operations. Further, the neural network processing may be performed for some or all of the graphics texture data that is fetched from memory. That is, a given neural texturing job that is executed by a neural network processing circuit may generally any suitable portion of graphics texture data (and the processing of the graphics texture data could, for example, be divided between multiple neural texturing jobs, if desired).

In fact, a particular effect and benefit of using the neural network based texture compression/decompression schemes of the technology described herein is that this then offers increased flexibility and configurability as to how the graphics texture data is processed (whereas traditional texture compression schemes are typically relatively constrained by what is supported in the respective hardware decompression circuits)).

For example, a single neural network (or set of neural networks) could be configured and trained to process any and all types of graphics textures. However, this may not offer optimal compression/decompression for all different graphics textures, such that for improved performance, it may be desired to have a plurality of different neural networks available that can be selected, e.g. based on the texture (type/content) that is required, to perform the required texture decompression.

In the simplest such case, separate neural networks may be used for each different texture (type/content) and each level of detail. In that case, the graphics processor should select, based on the texture (type/content) and level of detail that is required, the appropriate neural network or networks from a plurality of neural networks that are available and then load data for the selected neural network(s) into the neural processing circuit so that the required graphics texture can be processed using the selected neural network(s) accordingly.

However, the present Applicants recognise that it would also be possible to configure a single, same neural network to perform compression for a group of plural, different (albeit potentially related) textures (such that a corresponding same neural network can perform decompression for any individual textures within that group of textures). For instance, when configuring (training) the neural networks to perform the desired texture compression/decompression, the user or system may select a group of plural, different textures (or texture types) that can/should be compressed/decompressed using the same neural network, and then use that same neural network to individually compress multiple ones of the different textures within the selected group. The selection of which different textures can or should be compressed using the same neural network may be based on various factors including, but not limited to, an expected texture similarity. This could be determined by the user or could also be determined automatically by another neural network as part of the compression process.

In that case, texturing requests for any of the individual textures (types) within a group of plural different textures (types) may be processed using a single, same neural network, thus potentially reducing the instances of having to load/re-load data for multiple different neural networks into the graphics processor.

There are various other possibilities in this regard in terms of exploiting the increased configurability or flexibility that can be achieved using neural network based texture compression/decompression schemes.

The neural networks may generally be configured to perform the desired neural network processing in any suitable manner. Typically this will be done through training of the neural networks, in embodiments in a supervised manner. In embodiments, the training may comprise transfer learning, where a base model is generated and then transfer learning is performed to tune that base model for different output requirements (e.g. different textures, etc., as discussed above), but various arrangements would of course be possible in this regard. Thus, a given neural network can be trained to provide whatever outputs are desired based on an input set of (compressed) graphics texture data. Likewise, multiple neural networks may be used together to extend the range of outputs. Similarly, any suitable neural network architecture (models) may be used. For example, in some embodiments, the neural network(s) may comprise multi-layer perceptrons, such as convolutional neural networks. However, other neural network architecture (models) may also be suitably used.

In embodiments, and in embodiments in addition to any local storage that may be used for storing graphics texture, the neural network processing circuit is also associated with a neural network buffer for storing data (structures) for one or more neural networks (i.e. a model, and its associated weights, etc., defining the neural network, or part thereof) for performing the neural network processing. In order to perform neural network based texture processing, the graphics processor is thus in embodiments operable to load in data (structures) for one or more selected neural networks to such neural network buffer so that the neural network processing circuit can then execute the selected neural networks to perform the desired texture related neural network processing.

It will be appreciated here that loading in data for a neural network may involve loading in a neural network ‘in full’ (i.e. loading in all data, such as weights, etc., required to execute the neural network). However, this is not necessarily the case and in some embodiments the data that is loaded in for storing in the neural network buffer may be less than the ‘full’ neural network. For example, it could be the case that the neural network processing is performed as a number of smaller neural tasks, each of which executes part of the neural network processing (representing a portion of the ‘full’ neural network).

Accordingly, according to embodiments, the neural network processing may be executed as a plurality of smaller neural tasks, and the data for each neural task may be fetched (i.e. stored in the neural network buffer), processed, and output (in embodiments to an internal buffer) separately.

It could also be the case, e.g., and in particular, when transfer learning is applied, that the different neural networks may be generated from a same, base neural network such that the different neural networks may each comprise a set of one or more layers that is common to the different neural networks and a set of one or more layers that is specific to that particular neural network. In that case, the common layers may already be stored locally and the data that is to be loaded in may comprise only the layers that are specific to the particular neural network that is required.

Various arrangements would be possible in this regard.

As alluded to above, it will be appreciated that there may be significant bandwidth associated with supporting such neural network based texture processing operations. The technology described herein may therefore be particularly beneficial for graphics processors that support neural network based texture processing as in that context there may be increased bandwidth costs and/or latency associated with loading in the neural network data structures to perform the required neural network processing, and the particular control operations of the technology described herein may thus be performed to try to avoid doing that, e.g. when it is acceptable to reduce the output quality, as discussed above.

Various arrangements would be possible in this regard.

The technology described herein may generally find application in any suitable graphics processing system.

The technology described herein can be used for all forms of output that a graphics processor and graphics processing pipeline may be used to generate. In particular, the technology described herein may be used both for generating graphics processing outputs, such as frames for display, render to texture outputs, etc., or for general purpose (non-graphics) outputs. For example, for graphics outputs, the texture data may relate to colour, etc., data, as discussed above. For general purpose graphics processing operation, texture maps may correspondingly be used to store arbitrary data as desired (with the texturing interpolation/filtering operations then providing means for approximating arbitrary functions with data tables). Various arrangements would be possible in this regard.

In some embodiments, the graphics processor and graphics processing system comprises, and/or is in communication with, one or more memories and/or memory devices that store the data described herein, and/or store software for performing the processes described herein. The graphics processor and graphics processing system may also be in communication with a host microprocessor, and/or with a display for displaying images based on the data generated by the graphics processor and graphics processing system.

In an embodiment, the various functions of the technology described herein are carried out on a single graphics processing platform that generates and outputs the rendered fragment data that is, e.g., written to a frame buffer for a display device.

The technology described herein can be implemented in any suitable system, such as a suitably configured micro-processor based system. In an embodiment, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, and pipelines of the technology described herein in may comprise a suitable processor or processors, controller or controllers, functional units, circuits/circuitry, processing logic, microprocessor arrangements, etc., that are operable to perform the various functions, etc., such as appropriately configured dedicated hardware elements or processing circuits/circuitry, and/or programmable hardware elements or processing circuits/circuitry that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits/circuitry, if desired.

Thus the technology described herein extends to a graphics processor and to a graphics processing platform including the apparatus of or operated in accordance with any one or more of the embodiments of the technology described herein. Subject to any hardware necessary to carry out the specific functions discussed above, such a graphics processor can otherwise include any one or more or all of the usual functional units, etc., that graphics processors include.

It will also be appreciated by those skilled in the art that all of the described embodiments and embodiments of the technology described herein can, and in an embodiment do, include, as appropriate, any one or more or all of the optional features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processors, a computer program element comprising computer software code portions for performing the methods herein described when the program element is run on a data processor, and a computer program comprising code adapted to perform all the steps of a method or of the methods herein described when the program is run on a data processing system. The data processor may be a microprocessor system, a programmable FPGA (field programmable gate array), etc.

The technology described herein also extends to a computer software carrier comprising such software which when used to operate a graphics processor, renderer or microprocessor system comprising a data processor causes in conjunction with said data processor said processor, renderer or system to carry out the steps of the methods of the technology described herein. Such a computer software carrier could be a physical storage medium such as a ROM chip, RAM, flash memory, CD ROM or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible medium, such as a non-transitory computer readable medium, for example, diskette, CD ROM, ROM, RAM, flash memory or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Various embodiments will now be described by way of example only and with reference to the figures.

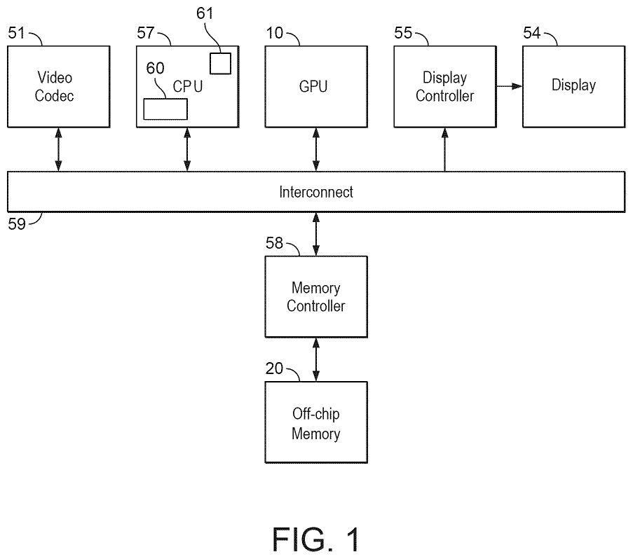

FIG. 1 shows an exemplary data processing system in which the technology described herein and the present embodiment may be implemented.

The exemplary data processing system shown in FIG. 1 comprises a host processor comprising a central processing unit (CPU) 57, a graphics processing unit (GPU) 10, a video codec 51, a display controller 55, and a memory controller 58. As shown in FIG. 1, these units communicate via an interconnect 59 and have access to an off-chip memory system (memory) 20. In this system the graphics processing unit 10, video codec 51, and/or a central processing unit 57 will generate frames (images) to be displayed, and the display controller 55 will then provide the frames to a display 54 for display.

In use of this system, an application 60, such as a game, executing on the host processor (CPU) 57, will, for example, require the display of frames on the display 54. To do this, the application 60 will submit appropriate commands and data to a driver 61 for the graphics processing unit 10 that is executing on the host processor (CPU) 57. The driver 61 will then generate appropriate commands and data to cause the graphics processing unit 10 to render appropriate frames for display and to store those frames in appropriate frame buffers, e.g. in the main memory 20. The display controller 55 will then read those frames into a buffer for the display from where they are then read out and displayed on the display panel of the display 54.

The present embodiments and the technology described herein relate in particular to the situation where the graphics processing unit 10 is using a texture when rendering a frame for output (e.g. for display). Such textures will comprise arrays of data elements (texture elements (texels)), each having an associated data value or values in the data format of the texture in question.

The textures will typically comprise images that are to be applied to graphics entities, such as primitives, to be rendered, and will normally be stored in the off-chip memory 20 from where they can then be read in by the graphics processing unit 10 when required. In particular, when using a texture to generate a render output, the graphics processing unit 10 will fetch the texture data from the memory 20 and store it in a local, texel cache of the graphics processing unit 10. The texture data will then be read from the texel cache, when needed, and used to generate the render output, e.g. frame for display.

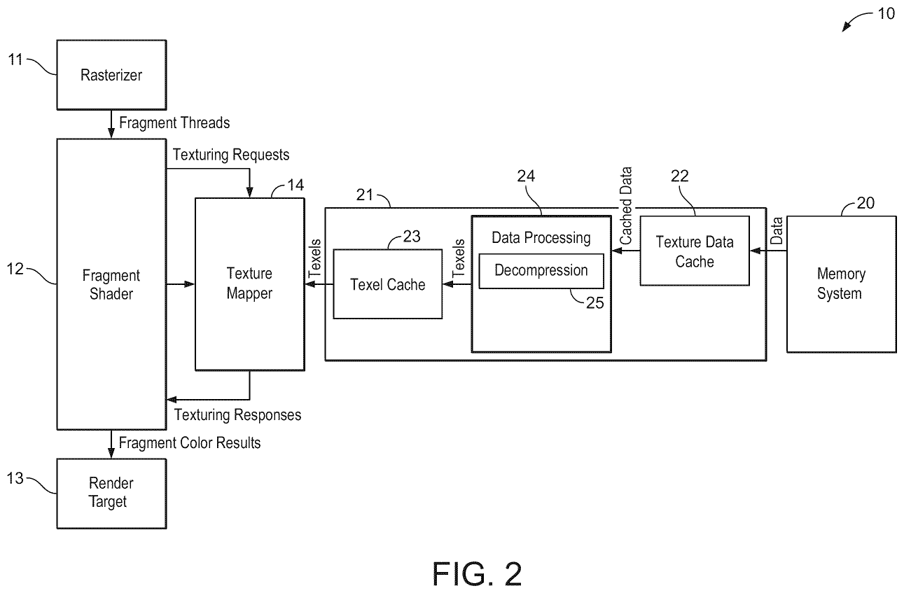

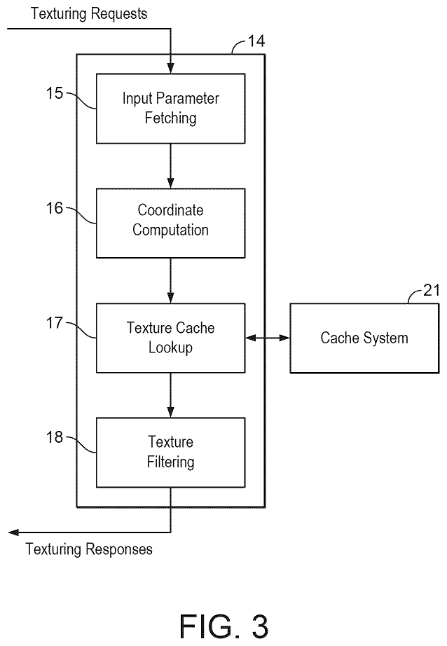

FIGS. 2 and 3 shows schematically the elements of the graphics processing unit 10 of the system shown in FIG. 1 that are particularly relevant to graphics processor texturing operations. As will be appreciated by those skilled in the art, there may be other elements of the graphics processing unit 10 that are not illustrated in FIGS. 2 and 3.

As shown in FIG. 2, the graphics processing unit 10 implements a graphics processing pipeline that includes, inter alia, a rasterizer 11, a renderer in the form of a (programmable) fragment shader 12, a buffer 13 (e.g. in memory 20) for storing the output render target (e.g. frame to be displayed), and a texture mapping unit (texture mapper) 14, and is in communication with the memory system 20.

The system memory 20 will store, inter alia, graphics textures to be used by the graphics processing unit 10. The system memory 20 may, e.g., be main memory (e.g. DDR-SDRAM (Double Data Rate Synchronous Dynamic Memory), non-volatile memory, such as Flash), e.g. a disk drive or other storage medium (e.g. a hard disk, a RAID array of hard disks or a solid state disk (SSD)) of or accessible to the host system in which the graphics processing unit 10 is located, and may be an internal storage medium of the host system, or an external or removable storage medium.

As shown in FIG. 3, the texture mapper 14 may comprise, for example, an input parameter fetching unit 15, a coordinate computation unit 16, a texel cache lookup unit 17, and a texture filtering unit 18.

As shown in FIG. 2, the texture mapper 14 interfaces with the memory system 20 via a texture cache system 21. The texture cache system 21, as shown in FIG. 2, contains a first cache 22 (a “texture data” cache) that receives data from the system memory 20, and a second cache 23 (a “texel” cache) that interfaces with the texture mapper 14 and from which the texture mapper 14 may read data of texels required for its texturing operations. The texture cache system 21 also includes a data processing unit 24 that is operable to read data from the first, texture data cache 22, process that texture data, and then provide that data to the second, texel cache 23.

The first 22 and second 23 caches of the texture cache system 21 are local memory for storing texture data, and may, e.g., comprise a RAM. They may be in the form of an SRAM memory. They each comprise a plurality of cache-lines. The second cache 23 of the cache system 21 may have a greater capacity than the first cache 22, such as having twice or four times as many cache lines as the first cache. Other arrangements would, of course, be possible.

The arrows in FIGS. 2 and 3 indicate the main ways in which data flows between the various components of the graphics processing pipeline and the memory 20. There may also be other communication routes or directions that are not indicated.

The rasterizer 11 receives as its input primitives (e.g. triangles) to be used to generate a render output, such as a frame to be displayed, and rasterizes those primitives into individual graphics fragments for processing. To do this, the rasterizer 11 rasterizes the primitives to sample points representing the render output, and generates graphics fragments representing appropriate sampling positions for rendering the primitives. The fragments generated by the rasterizer 11 are then sent onwards to the fragment shader (renderer) 12 for shading.

The fragment shader 12 executes a shader program or programs for the fragments issued by the rasterizer 11 in order to render (shade) the fragments. The fragments are processed using execution threads in the shader core, with the threads executing the shader program(s) that are to be used to process the fragments. A thread is executed for each sampling position that is to be shaded.

The shader programs may include (zero, one, or more) texturing instructions (texturing operations) that are required to be executed by the texture mapper 14. When a texturing instruction is encountered by the fragment shader 12, a texturing message is sent from the fragment shader 12 to the texture mapper 14, requesting the texture mapper 14 to follow one or more texturing instructions to perform texture processing. After the texture mapper 14 has finished its texture processing (carrying out these instructions), the final result (a texture response) is sent back to the fragment shader 12 in a response message for use when shading the fragment in question.

The texture mapper 14 includes suitable processing circuitry to perform texturing instructions. This processing circuitry may, e.g., be in the form of a dedicated hardware element that is configured appropriately, or it may, e.g., comprise programmable processing circuitry that has been programmed appropriately. In an embodiment, a dedicated hardware texture mapper is used.

The “shaded” fragment from the fragment shader 12 is then stored as part of the output render target in the buffer 13. For example, for a tile-based graphics processor, the buffer 13 may be a tile buffer associated with the graphics processing unit 10, with the contents of the tile buffer, once populated, then being written to the main memory 20, e.g. for subsequent display.

Thus, when instructed by the fragment shader 12, the texture mapper 14 reads textures from the memory 20 (as required), performs various processing steps, and returns a colour sampled from the texture back to the fragment shader 12.

As part of this processing, the input parameter fetching unit 15 may, for example, read in the parameters of the texture to be sampled and the parameters of how to sample the texture from appropriate state information for the texture. For example, the input parameter fetching unit 15 may receive the texturing instruction message from the fragment shader 12 and this message may indicate the texture to be used (e.g. a texture field may be provided that includes a texture descriptor) and the sampling position coordinates at which to perform the texture operation.

The coordinate computation unit 16 may, for example, receive the texturing request message from the fragment shader 12 containing the coordinates to sample in the texture, together with the parameters read by the input parameter fetching unit, and determine the actual texel indices (i.e. the texels or texture data elements) in the texture to be looked up from the texel cache system 21 to perform the texture operation.

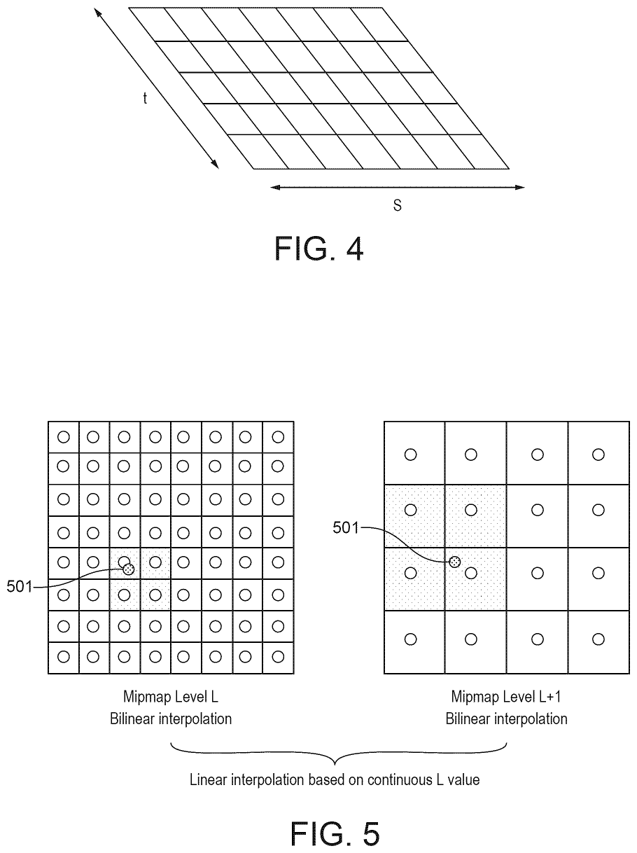

For instance, as mentioned earlier, graphics texture data is compressed in “blocks” to facilitate random access to the graphics texture. FIG. 4 shows an example of (a block of) graphics texture data, in which the texture surface is divided by into subregions that can be addressed based on respective texture surface coordinates (e.g. a pair of (s,t) co-ordinates as shown in FIG. 4). The coordinate computation unit 16 may thus map a texturing request onto the texture surface co-ordinates.

The texture cache lookup unit 17 may, for example, check whether the required texture data (i.e. the block of texture data containing texture data at the specified texture surfaces (s,t) coordinates) is stored in the second (texel) cache 23 of the texture cache system 21 and, if present, read the texture data from the second (texel) cache 23. Thus, the texture cache lookup unit 17 may check whether the required texture data elements (texels) are already stored in the second (texel) cache 23 of the texture cache system 21. If the required data is not cached locally, a request is made to fetch the required data from memory (or from a lower level of the texture cache system 21, as the case may be) into the second (texel) cache 23.

The texturing instruction is then (in embodiments) parked into a parking buffer (not shown) to await further processing (e.g. pending the required data being fetched from the system memory and loaded into the texture cache). Once the required texture data (texture data elements) have been loaded into the second (texel) cache 23, data indicating the cache line and byte offsets where each of the texture data elements required to perform the texture operation are stored in the second (texel) cache 23 so that they can be forwarded to the texture mapper 14 as part of the texturing response.

It will be appreciated in this respect that the graphics texture data elements (texels) will typically have other than a direct correspondence with the sampling positions that are being texture mapped. Thus, further processing is typically performed to determine how the texture should be applied based on the shape, size, angle, scale, etc. of the surface that is being texture mapped. These operations are typically referred to as texture filtering operations (and will also be referred to as such in the present application). Thus, the texture cache lookup may typically lookup plural texels that are then suitably processed/filtered to determine the appearance that the associated sampling position should have.

For instance, for a typical bilinear lookup, texture data from four texels are read from a 2×2 texel region of the texture. The texture filtering unit 18 may, for example, receive the four texels of the bilinear lookup from the texel cache lookup unit, and determine interpolation weights and compute a weighted average of the texture data for the sampling position in question.

To simplify such texture filtering operations, graphics textures are often stored as a set of mipmap levels, with the different mipmap levels representing different resolution versions of the same textures. In that case, the lookup may be for textures from one or more mipmaps levels. For example, when performing anisotropic filtering, texture data from four texels may be read from a 2×2 texel region of each of two mipmap levels of the texture, with filtering then performed between the two mipmaps levels. FIG. 5 shows an example in which a lookup is being performed for a particular sampling position 501. As shown in FIG. 5, bilinear filtering is performed for the texels within respective 2×2 texel regions within two mipmap levels (level L and L+1), and linear interpolation is then performed between the two mipmap levels based on the continuous L value (overall, effectively, trilinear filtering).

Various other arrangements would be possible for filtering the texture data depending on the texture operation that is to be performed.

The filtered (interpolated) texture data for the sampling position in question is then output to (returned to) the fragment shader 12.

To facilitate storing the texture data in the memory 20 the texture data is typically (and in the present embodiment) stored in a compressed format. As mentioned above, this reduces the memory footprint of the textures in the memory 20, and also reduces the bandwidth (and energy) for fetching the texture data into the graphics processor. However, this means that the graphics processing unit 10 therefore needs to decompress texture data that is read in from the memory 20 so that the texture data is decompressed into a suitable format for use by the graphics processing operation for which the texturing request is being made.

The decompression of texture data can be performed at any suitable point along the access path to the memory 20 in which the texture data is stored. For example, as shown in FIG. 2, the data processing unit 24 of the texture cache system 21 includes one or more (hardware) decompression circuits 25 that are operable to perform decompression as data is transferred from the first, texture data cache 22 to the second, texel cache 23. Other arrangements would however be possible. For example, the texture decompression could in principle be performed at other suitable points along the memory access path.

Traditionally, each of the one or more (hardware) decompression circuits 25 supports (only) a single texture compression scheme. Thus, for each texture compression that is desired to be supported, a separate, dedicated decompression circuit 25 may be provided (with other texture compression schemes either being unsupported, or potentially being handled in software, e.g. by executing a compute shader program to perform the required decompression, which is not normally efficient). Because the decompression circuit 25 is designed and optimised for a particular texture compression scheme, this type of arrangement can be relatively inflexible. For example, a given texture compression/decompression scheme may support only a certain number of colour channels (e.g. three colour channels for data in RGB or YUV format, or four colour channels for data in RGBA format). However, modern graphics processing increasingly requires additional channels to be supported, and to address this, those channels may be stored as separate textures which then have to be obtained and decompressed separately to the colour channels.

Neural network processing therefore offers a promising approach for graphics texture compression as neural networks can be suitably configured (i.e. trained) to compress/decompress graphics textures in any desired format, such that neural network based texture compression/decompression can provide a more flexible or configurable approach for processing graphics texture data. For instance, neural network based texture compression offers possibilities for compressing multiple different graphics textures, at multiple different levels of detail, multiple different aspect ratios, etc., using appropriate neural networks. Further, as mentioned above, neural network based texture compression may be able to provide higher compression rates and image quality.

As will be explained further below, the graphics processing unit 10 in the present embodiments is provided with a suitable neural network processing circuit that can be used to perform neural network processing and thus, by loading suitably selected neural networks into the graphics processing unit 10, the neural network processing circuit, can be used to execute the selected neural networks as required in order to perform graphics texture decompression into a desired format.

This therefore provides a more configurable approach as the selected neural network(s) can be loaded in as and when required to perform the desired neural network processing, thus avoiding the constraints associated with using fixed decompression circuits 25, e.g. as may be done in more traditional graphics processor arrangements. Thus, the neural network processing circuit may be configured and optimised for neural network execution, but is free to execute any suitable and desired neural networks, which can provide much greater configurability or support for performing different types of (neural network based texture) compression/decompression schemes. That is, rather than having specific hardware circuits to support specific compression schemes (with multiple different hardware circuits thus being required to support multiple different compression schemes, with associated silicon area costs), the approach according to the present embodiments, where an appropriate neural network processing circuit is available to accelerate neural network processing, means that the same neural network processing circuit (hardware) can be used to execute different neural networks, e.g. by changing the weights/neural network model using software.

In this respect, it will be appreciated that neural networks can be (and already are) used for various image processing operations, including in a graphics processing context for image enhancement (“de-noising”), segmentation, “anti-aliasing”, supersampling, etc., in which case a suitable input image may be processed using a neural network to provide a desired output image, and also for image compression. Neural networks are therefore also well-suited for graphics texture compression.

For instance, a neural network may operate upon suitable input data (e.g. such as an image) to ultimately provide a desired output. In the context of graphics texture compression, a neural network may thus be used to process input data, e.g. in the form of a graphics texture that is to be compressed, into a desired output, in this case a compressed format version of that graphics texture. Correspondingly, another (e.g. ‘reverse’) neural network may be used to process (i.e. decompress) such a compressed format version of a block of graphics texture data back into graphics texture data in a suitable format for use by a graphics processor texturing operation.

These compression/decompression processes may thus generally be considered as examples of neural network “inferencing” processes.

In general, a neural network will typically process the input data (e.g. texture data to be compressed/decompressed) according to a network of operators, each operator performing a particular operation. The operations will generally be performed sequentially to produce desired output data (e.g. based on the input texture data). Each operation may be referred to as a “layer” of neural network processing.

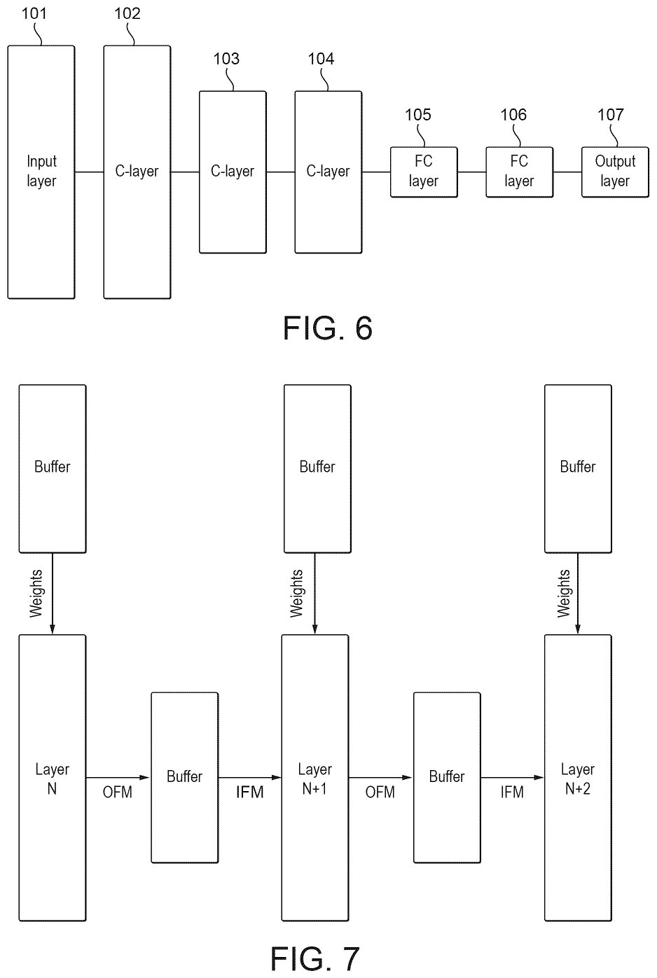

Hence, neural network processing may comprise a sequence of “layers” of processing, such that the output from each layer is used as an input to a next layer of processing. FIG. 6 shows an exemplary sequence of layers of neural network processing from an initial input layer 101 to a final output layer 107, between which are layers comprising various convolutional layers (C-layers) 102, 103, 104, and fully-connected layers (FC layers) 105, 106. Such a neural network may also comprise other additional layer types (which are not shown in FIG. 6), such as a deconvolution layer, as appropriate.

The input layer 101 may be configured to receive input data (e.g. an image to be compressed/decompressed), and to provide that input data in a suitable form (e.g. as an array of data elements, otherwise known as a “feature map”) for use by subsequent neural network layers.

The feature map will generally comprise a three-dimensional array of data elements, each data element having data associated therewith. The feature map may have a width (W), a height (H) and a depth (C), wherein the width (W) and height (H) may be defined as the number of data elements in the width and height direction respectively, and the depth (C) may correspond to a number of data channels. For example, in the case of input data comprising an image (e.g. a graphics texture), the width and height of the array provided by the input layer may correspond to a number of data positions (e.g. pixels/texels) along the width and height direction of the image respectively, whilst the channels may comprise the RGB (A) colour channels of the image. To allow for random access, the image may be compressed and decompressed in multiple, smaller, blocks/regions.

After the input layer, there may be one or more other layers of neural network processing (e.g. including convolutional layers, fully-connected layers, pooling layers, deconvolution layers, or any other layers of neural network processing that may be present).

Generally, a layer of neural network processing will process an input feature map (IFM) in order to generate a corresponding output feature map (OFM) (e.g. in the case of a convolutional layer, deconvolution layer, or pooling layer), or output value (e.g. a probability in the case of a fully-connected layer). The output generated by a layer of neural network processing will be used as the input for a next layer of neural network processing in the sequence, and so on. This is illustrated in FIG. 7.

The operation performed by each layer of neural network processing may comprise any suitable operation which manipulates an input (feature map) to provide an output (feature map). The operation may require process parameters (e.g. such as weights for a filter or “kernel”) which may be specific to a particular layer of neural network processing. Hence, as shown in FIG. 7, suitable process parameters (e.g. weights and biases) may be read from working memory (e.g. a buffer) in order to perform each layer of neural network processing.

With reference to FIG. 6, the final layer of neural network processing in the sequence may comprise an output layer 107. The output layer may process an input feature map to generate useful output data (e.g. an output compressed texture/decompressed texture block in the case of graphics texture data compression/decompression schemes).

Whilst FIG. 6 shows an example of a particular convolutional neural network, it will be appreciated that a neural network may have various other layer types, and/or network architectures (e.g. a recurrent neural network architecture).

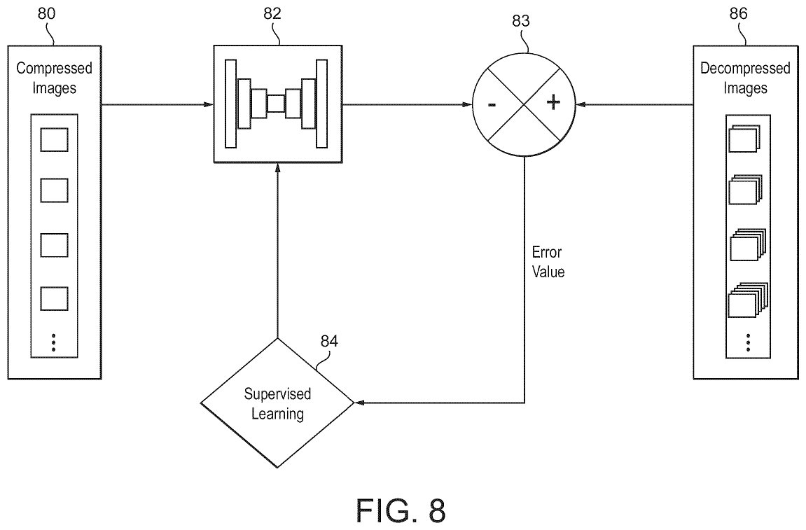

An aspect of the technology described herein therefore relates to the use of neural networks, such as those described above, for graphics texture compression, and correspondingly for graphics texture decompression. For example, as alluded to above, a neural network can be suitably trained to compress graphics texture data (and to do so in such a manner that permits random access to the graphics texture data), and another (reverse) neural network can correspondingly be trained to decompress graphics texture data that has been compressed in this way. This training can be done in any suitably and desired manner for training a neural network. For example, in embodiments, this is done by a process of “supervised learning”, as shown in FIG. 8.

FIG. 8 thus shows schematically an example of a training process in which supervised learning is performed (at step 84) in order to train a neural network 82 to perform graphics texture compression/decompression. In particular, in this example, the neural network 82 is being trained to perform graphics texture decompression. In this case, a set of compressed image regions (i.e. “blocks” of compressed texture data) 80 is provided as input to the neural network 82. The neural network 82 then learns to decompress these compressed images/regions 80 by comparing its output with a corresponding set of ground truth decompressed images/regions 86 (at step 83) and using the resulting error value to guide the supervised learning (step 84). In this example, the neural network 82 learns to decompress each channel individually. Also, each channel in the compressed texture has the same width and height.

However, the training can generally be done in various ways as desired depending on the neural network processing that the neural network(s) is desired to do, as will be discussed further below.

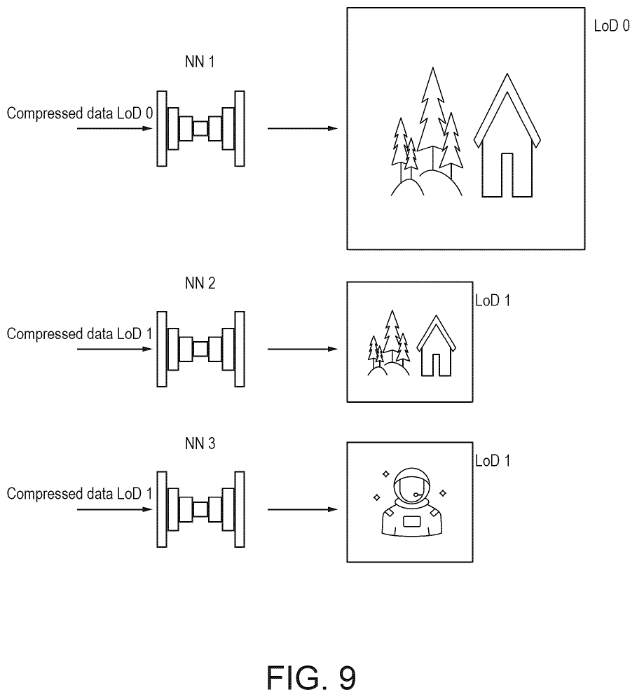

For example, FIG. 9 shows a plurality of different neural networks that have been trained separately (although transfer learning may generally be used for this training) with each neural network being configured and training to process a different type of texture data (in this example at a single level of detail). Thus, as shown in FIG. 9, a first neural network (NN1) may be provided that is configured to output a first texture at a first level of detail (LoD0). Correspondingly a second neural network (NN2) is provided that is configured to output the same first texture but at a second level of detail (LoD1). FIG. 9 also shows a third neural network (NN3) that is configured to output a second, different texture at the second level of detail (LoD1). In this way, many different neural networks may be trained and the appropriate neural network can then be selected, as will be discussed further below, depending on the texture that is required, the desired level of detail, etc., and loaded in to the graphics processor accordingly to perform the neural network texture decompression.

Although in FIG. 9 there are respective, different neural networks for different textures and levels of detail, it will be appreciated that this need not be the case, and a given neural network may generally be operable and configured to process different types of texture, at different levels of detail, etc. Thus, a particular benefit of neural network based texture compression/decompression schemes is that by suitable configuration and training of a neural network (or set of neural networks) it is possible to extend or generalise the functionality of the neural network, thus potentially reducing the number of different neural networks that may be required (and hence potentially reduce memory bandwidth).

It will be appreciated from the above examples that neural network processing may thus provide various benefits in the context of graphics texture compression/decompression such that it is desirable to more efficiently support such neural network based texture compression/decompression on graphics processors.

This support could be achieved by including a suitable (dedicated) neural network texture decompression circuit, e.g. as another decompression circuit 25 within the data processing unit 24 of the texel cache system 21, and providing suitable interfaces for that network texture decompression circuit to load in any selected neural networks, as required.

In this respect, the present Applicants however recognise that there are various other examples of (non-graphics texture related) neural network processing that may be performed when performing graphics processing, and that it may already be advantageous for the graphics processor to have a separate on-chip neural engine to support this, which (existing) neural engine can therefore advantageously also be used to support neural network based texture compression/decompression schemes.

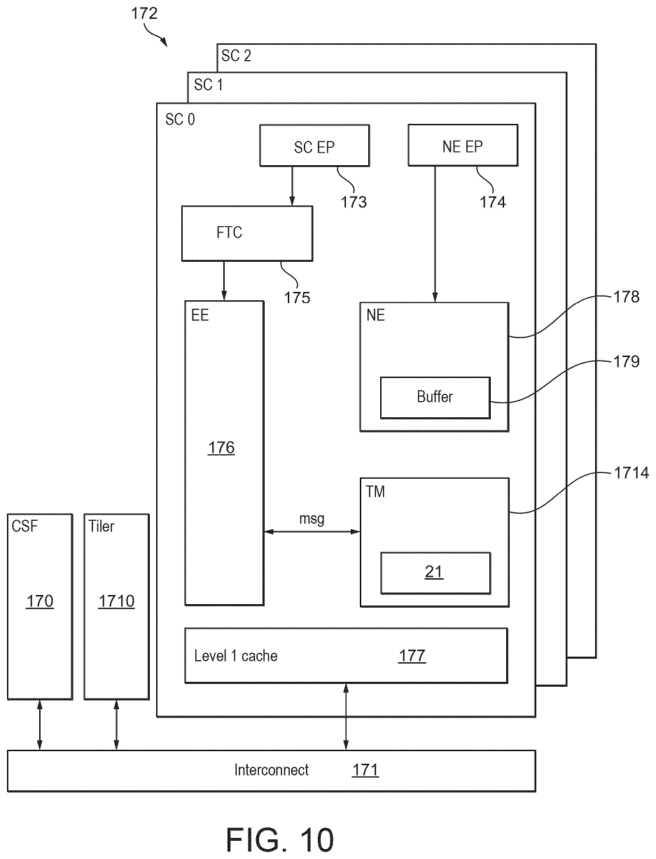

An example of a graphics processing unit including such a neural engine is shown in FIG. 10. FIG. 10 shows schematically certain relevant elements and components of a graphics processing unit.

As shown in FIG. 10, the graphics processor includes one or more shader (processing) cores 172 that are provided along the same interconnect 171 (which interconnect 171 may, for example, provide communication to a shared (L2) cache (not shown) which is operable to communication with the off-chip memory system).

A command processing circuit (in the form of a command stream frontend, “CSF”) 170 is also provided that is operable to communicate over the interconnect 171 with the respective shader (processing) cores 172 to schedule processing jobs. In the present embodiments the graphics processor is operable to perform tile-based rendering and so also includes a separate tiler unit 1710 that is also operable to communicate over the interconnect 171 with the respective shader (processing) cores 172 to perform tiling operations.

FIG. 10 shows schematically the relevant configuration of one shader core (SC0), but as will be appreciated by those skilled in the art, any further shader cores 172 of the graphics processor will be configured in a corresponding manner.

As will be appreciated by those skilled in the art there may be other elements of the graphics processor that are not illustrated in FIG. 10. It should also be noted here that FIG. 10 is only schematic, and that, for example, in practice the shown functional units may share significant hardware circuits, even though they are shown schematically as separate units in FIG. 10. It will also be appreciated that each of the elements and units, etc., of the graphics processor as shown in FIG. 10 may, unless otherwise indicated, be implemented as desired and will accordingly comprise, e.g., appropriate circuits (processing logic), etc., for performing the necessary operation and functions.

As shown in FIG. 10 the (and each) graphics processor shader (processing) core (SC0) comprises a programmable processing unit (circuit) in the form of execution engine (EE) 176 that perform processing operations by running small programs (often referred to as “shader” programs) for each “item” in an output to be generated such as a render target, e.g. frame. (An “item” in this regard may be, e.g. a vertex, one or more sampling positions, etc.) The shader cores will process each “item” by means of one or more execution threads which will execute the instructions of the shader program(s) in question for the “item” in question. Typically, there will be multiple execution threads each executing at the same time (in parallel).

The shader (processing) core (SC0) may also include, for example, an instruction cache (not shown) that stores instructions to be executed by the execution engine 176 to perform graphics processing operations.

The shader (processing) core (SC0) also includes an appropriate local (L1) cache 177, that is operable, e.g., to load into an appropriate cache, data, etc., to be processed by the execution engine 176, and to write data back to the memory system (via any shared cache system when present) (for data loads and stores for programs executed in the execution engine 176).

As shown in FIG. 10, the shader (processing) core (SC0) also includes a texture mapper unit in the form of texture mapping apparatus 1714, which is in communication with the execution engine 176, and which is operable to perform texturing operations. The texture mapping apparatus 1714 includes suitable processing circuitry to follow texturing instructions. In the present embodiments, this processing circuitry is in the form of one or more dedicated hardware elements that are configured appropriately, e.g. as discussed above. The texture mapping apparatus 1714 has a local buffer, which may correspond to texture cache system 21 discussed above, and is in embodiments also operable to fetch data from the memory system (although this is not shown in FIG. 10).

In order to perform graphics processing operations, the execution engine 176 will execute graphics shader programs (sequences of instructions) for respective execution threads (e.g. corresponding to respective sampling positions of a frame to be rendered). Accordingly, as shown in FIG. 10, the shader core (SC0) further comprises a shader core endpoint 173 that is operable to schedule processing work to the execution engine 176 and a corresponding fragment thread creator (generator) 175 that is operable to generate execution threads for execution by the execution engine 176 as desired. The fragment thread creator (generator) 175 in the present embodiments also includes a rasterizer, as will be explained further below.

The command stream frontend 170 may thus issue fragment processing jobs to the shader core endpoint 173 of a respective shader core accordingly. The command stream frontend 170 is also generally able to schedule other desired processing work for the graphics processor, including both normal graphics processing work, as well as compute and neural network processing work.

To facilitate the performance of neural network processing work using the graphics processor, the shader cores 172 of the graphics processor are in the embodiment shown in FIG. 10 each provided with a respective neural network processing circuit (neural engine, “NE”) 178. In FIG. 10, the neural engine 178 is provided with its own separate neural endpoint 174 to which neural network processing jobs can be submitted by the command stream frontend 170. The neural engine 178 is also provided with a respective neural buffer 179 for storing the required data for the neural network processing (which may include the data defining the neural network itself, including the weights, biases, etc., as well as the input/output feature maps for the neural network processing).

Thus, in FIG. 10, neural network processing work may be triggered by the command stream frontend 170 issuing a suitable processing task to a respective graphics processor shader core, which task is then scheduled to the neural engine 178 by the separate neural endpoint 174.

Thus, the graphics processing unit in FIG. 10 includes a dedicated “on chip” neural network processing circuit that is associated with, and local to, the graphics processor itself. This then means that the neural network processing circuit is operable, e.g., to utilise some of the graphics processor's existing resource (e.g. such that at least some functional units and resource (e.g. the overall job control, and any shared storage) of the graphics processing unit can effectively be shared between the neural network processing circuit and execution unit, for instance), whilst still allowing an improved (more optimised) performance compared to, e.g., the graphics processor only being able to perform neural network processing with general purpose execution in the execution unit (or using an entirely separate unit that is independent of the graphics processor, such as an entirely separate neural processing unit, “NPU”, that is operable to perform neural network processing on demand by the host processor (CPU) 57 and that is provided along the same interconnect (bus) 59 in parallel with the graphics processing unit 10).

The arrangement shown in FIG. 10 can thus work well to perform some neural network processing locally to the graphics processor. This can be particularly useful for neural network processing relating to other graphics processing operations such as when performing so-called “super sampling” and/or other “anti-aliasing” techniques using deep learning processing. Another example might be for de-noising applications when performing a ray tracing process.

The arrangement shown in FIG. 10 can also be used in the same way to perform neural network based texture decompression.

Thus, when performing fragment processing jobs, the command stream frontend 170 may send a processing job to the shader core endpoint 173, which then sends the primitives that are to be processed to the fragment thread creator 175. The fragment thread creator 175 then sends tasks to the execution engine 176 to execute the desired shader program. The execution engine 176 then executes instructions from the shader program. In response to executing a texturing instruction, the execution engine 176 then messages the texture mapping unit (texture mapper) 1714, e.g. in the normal manner, to request the required graphics texture data.

Thus, in the present embodiments, in the same manner described above, the texture mapping unit (texture mapper) 1714 checks its buffer (e.g. the texture cache system 21) to determine whether the requested texture data (at the desired (s,t) co-ordinates) has already been decompressed and is already locally available. If so, i.e. if there is a hit in the texture cache system 21, the requested texture data is returned from the buffer to the texture mapping unit (texture mapper) 1714, filtered (interpolated) as required, and the filtered (interpolated) value is then returned to the execution engine 176.

On the other hand, if the requested texture data is not already locally available (i.e. there is a miss in the texture cache system 21), that texture data needs to be fetched in by the texture mapping unit (texture mapper) 1714 and then suitably decompressed for use by the graphics processor. When neural network based texture decompression is being performed, if new graphics texture data needs to be fetched in, the corresponding neural network data or data structures for processing that graphics texture data also (first) need to be loaded in (e.g. to the neural buffer 179 of the neural engine 178) so that the graphics texture data can be processed accordingly.

Thus, if the requested texture data is not already locally available in the texture cache system 21, the requested texture data is fetched in via the texture cache system 21, and then decompressed, but prior to (on in parallel with) fetching in the compressed texture data, the corresponding neural network data or data structures for processing that graphics texture data are also fetched. The compressed texture data is then processed accordingly using the corresponding neural network, and the decompressed texture data is then placed into the texture cache system 21 appropriately so that it can then be returned to the texture mapping unit (texture mapper) 1714, and ultimately to the execution engine 176.

Thus, in the present embodiments, the neural network based texture compression is supported by the neural engine 178 which acts in cooperation with the texture mapping system (i.e. the texture mapper 14 and texture cache system 21) to process any texture data that is to be decompressed by executing a corresponding set of neural networks.

Various other arrangements would of course be possible for supporting neural network based texture compression within a graphics processing unit.

It will be appreciated from the above that there may be significant memory bandwidth and/or processing latency associated with such graphics texturing operations when fetching in graphics texture data, especially when neural network based texture processing is performed such that it is not only the graphics texture data that needs to be fetched, but also the neural network data or data structures for processing that graphics texture data.

The present embodiments thus provide an improved graphics processor operation in which the processing is performed to (try to) reduce the memory bandwidth and/or processing latency associated with the graphics texturing operations.

Various embodiments will now be described in the context of a tile-based rendering system. It will be appreciated however that the technology described herein may also generally find application in other (e.g. immediate mode) rendering systems.

In a tile-based rendering system, the two-dimensional graphics processing (render) output (i.e. the output of the rendering process, such as an output frame to be displayed) is generated (rendered) as a plurality of smaller area regions, usually referred to as “tiles”. The render output is typically divided (by area) into regularly-sized and shaped rendering tiles (they are usually e.g. squares or rectangles).

When performing tile-based graphics processing, there will normally be some initial geometry processing, such as vertex processing (vertex shading) of attributes for vertices to be used for primitives for the render output being generated, to generate geometry (and other) data required for rendering the graphics processing output. The geometry processing will then be followed by a tiling/binning process that generates appropriate “binning” data structures for determining which geometry (e.g. primitives) needs to be processed for respective rendering tiles of the output being generated.

The tiles are each rendered separately (e.g. one after another). The rendered tiles are then combined to provide the complete render output (e.g. frame for display).

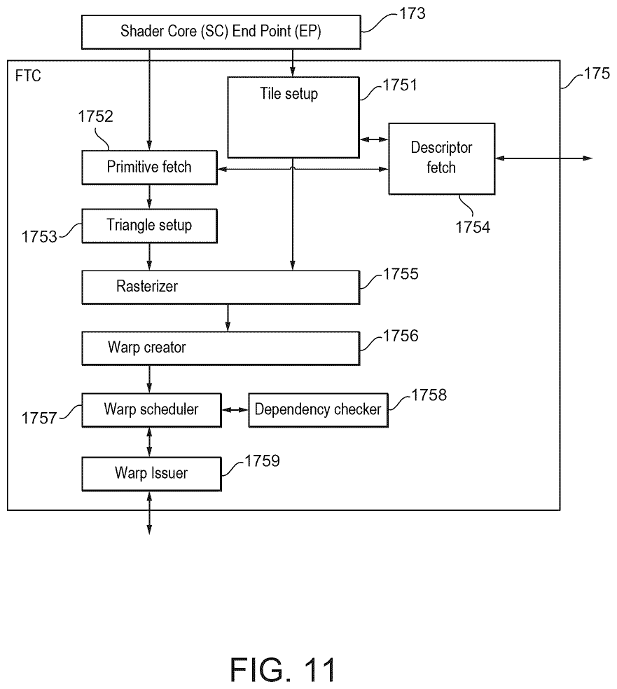

FIG. 11 shows in more detail the fragment thread creation process in a more traditional graphics processing unit when performing tile-based rendering.

Thus, as discussed above, in response to a command to render a particular tile, the shader core endpoint 173 may issue a rendering job to the fragment thread creator (generator) 175 for rendering the tile in question. A tile setup unit 1751 sets up the tile that is to be rendered based on suitable tile descriptors fetched in via descriptor fetch unit 1754. In parallel with this, primitive fetch unit 1752 fetches in the primitives that are to be processed for the current tile (e.g. by reading the appropriate “binning” data structures associated with that tile).

These primitives are then processed by a suitable pipeline of fragment frontend stages including a triangle (primitive) setup stage 1753 that performs primitive setup and a rasterizer 1755 that rasterises the primitives into respective fragments falling within the particular tile to be rendered. Warp creator 1756 then creates suitable execution thread groups (warps) for processing those fragments, and the warp scheduler 1757 then schedules these execution thread groups (warps) for execution (e.g. based on the dependency checker 1758) by the execution engine 176. The warp issuer 1759 issues the execution thread groups (warps) to the execution engine 176 according to the desired schedule. A fragment shader is then executed to perform further fragment processing.

In more traditional graphics processor operation, the rendering operation for a given tile is typically performed in a single pass, with the fragment shader executed after the fragment frontend stages generating the final output values for the tile. In the present embodiments, however, the rendering pipeline is instead implemented by performing two separate fragment processing passes, namely an initial processing pass that generates a set of fragment visibility information as to which primitives are visible at which sampling positions but does not process the fragments to completion to generate the final output values, as the final fragment processing operations are instead deferred to a subsequent further processing pass.

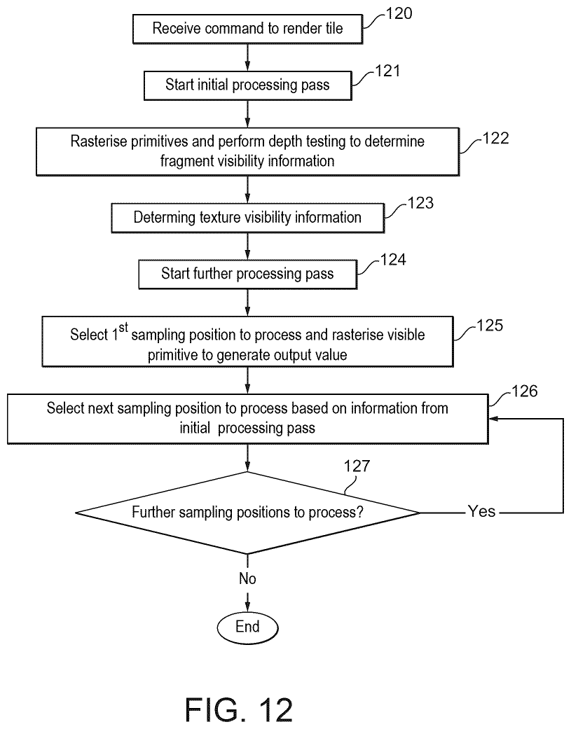

Thus, as shown in FIG. 12, in response to a command to render a tile (step 120), an initial processing pass is performed in respect of that tile (step 121). The initial processing pass rasterises the primitives to be processed for that tile into respective fragments and performs depth testing to determine which fragments (of which primitives) are visible at which sampling positions within the tile (step 122). As will be explained further below, the fragment visibility information is optionally then further processed to determine corresponding texture visibility information (step 123), indicating which graphics textures are visible at which sampling positions. The initial processing pass however stops at this point without generating the final render output values.

A subsequent further processing pass is then performed (step 124) to generate the final render output values. The further processing pass thus selects a first sampling position within the tile to process and rasterises the primitive that is visible at that sampling position to generate a respective output value (step 125). The further processing pass then selects a next sampling position to process (step 126), and so on, until there are no further sampling positions to process (step 127—no), at which point the further processing pass is finished, and the rendering of the tile is complete.

This process will then be repeated for the next tile, and so on, until the entire render output has been generated.

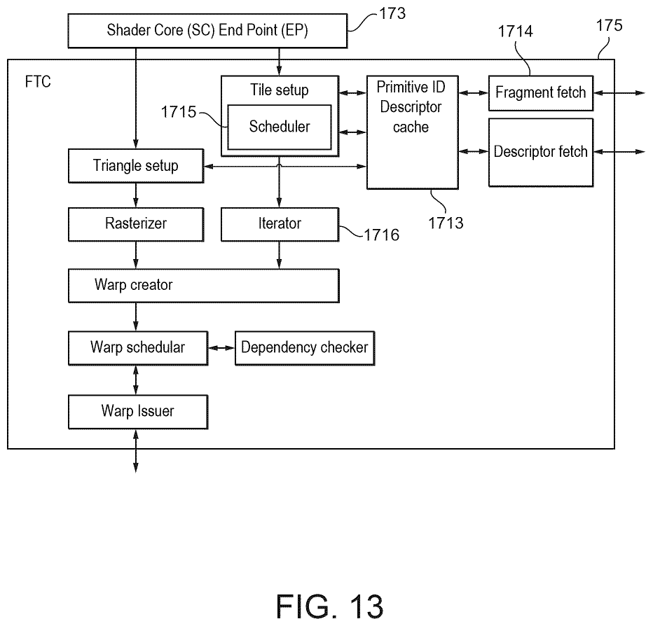

FIG. 13 shows the fragment thread creation in a graphics processing unit according to an embodiment in which additional hardware circuitry is provided to manage this two-pass operation. Thus, in the initial processing pass, execution thread groups (warps) are created for processing the fragments output from the rasterizer 1755 to determine a set of fragment visibility information. This is done by depth testing the fragments. The initial processing pass thus writes the depth buffer and also writes a suitable identifier of the primitive (fragment) that is visible at each sampling position within the tile.

During the further processing pass, the fragments are fetched for processing by fragment fetch unit 1714, and the set of fragment visibility information generated by the initial processing pass as to which primitives are visible at which sampling positions is then used together with information stored in a primitive ID descriptor cache 1713 as to which textures are to be applied for which primitives to determine an order in which the sampling positions should be processed. This is done in FIG. 13 by scheduler 1715 within tile setup unit 1751 and is fed to iterator 1716 that then creates suitable execution thread groups (warps) for processing the sampling positions in the desired order. The further processing pass then processes the primitives (fragments) that are visible at those sampling positions to generate the final output values.

Thus, it will be appreciated that in the technology described herein, some of the processing that is performed in the initial processing pass is essentially repeated during the further processing pass. The effect and benefit of performing the rendering in two separate passes however is that this then allows the further processing pass to be controlled based on the information gathered by the initial processing pass. In particular, according to the present embodiments, the order in which sampling positions are processed within a tile is controlled to try to optimise that order to increases instances where the same data or data structures can be used for the processing of consecutive sampling positions. This can in turn reduce the overall memory bandwidth and/or processing latency associated with the rendering of the tile.

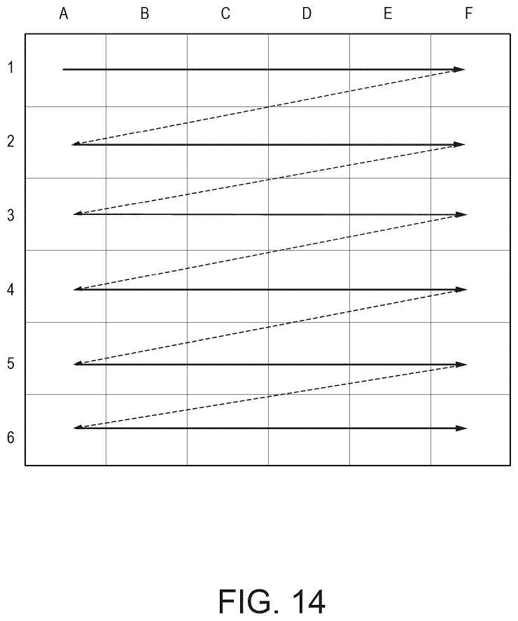

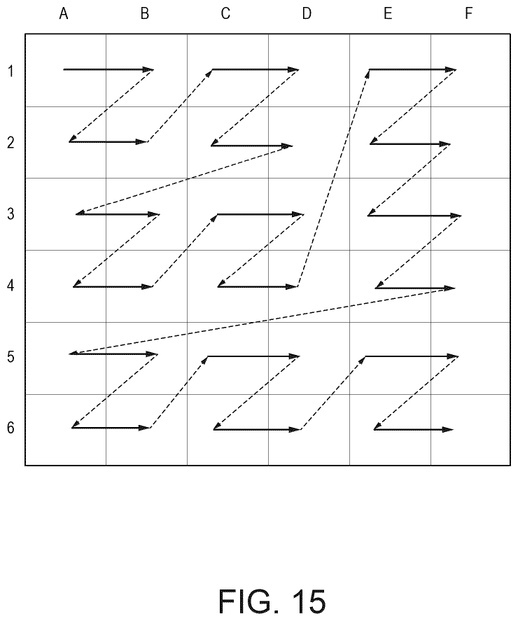

For instance, in a traditional tile-based rendering system, there will typically be a certain ‘set’ (or fixed) processing order for the sampling positions within a tile. FIG. 14 thus shows an example of a tile that comprises a 6×6 array of sampling positions (although it will be appreciated that rendering tiles will typically be larger than this, e.g. 16×16 or 64×64 sampling positions), in which when processing the tile, the sampling positions within that tile are processed according to scan line order. Other arrangements would however be possible, for example, using space-filling curves to try to increase spatial locality. An example of this is shown in FIG. 15 in which the sampling positions are processed according to a Morton (or “Z”) order. However, the present Applicants recognise that any particular ‘set’ (fixed) processing order may not necessarily be optimised for the tile in question.

According to the technology described herein, therefore, rather than always using a certain ‘set’ (or fixed) processing order for the sampling positions within a tile, the order in which the sampling positions is processed during the further processing pass is controlled based on the information gathered by the initial processing pass. This can then allow the order to be controlled, e.g., and in embodiments, to increase instances where the same data (structures) are used for consecutive sampling positions, hence reducing memory bandwidth and/or processing latency associated with fetching that data in.

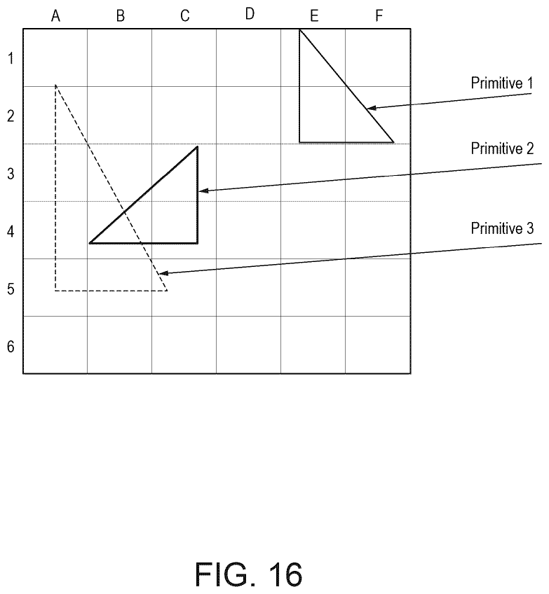

To illustrate this, FIG. 16 shows an example scene in which there are three primitives to be rendered within a particular tile.

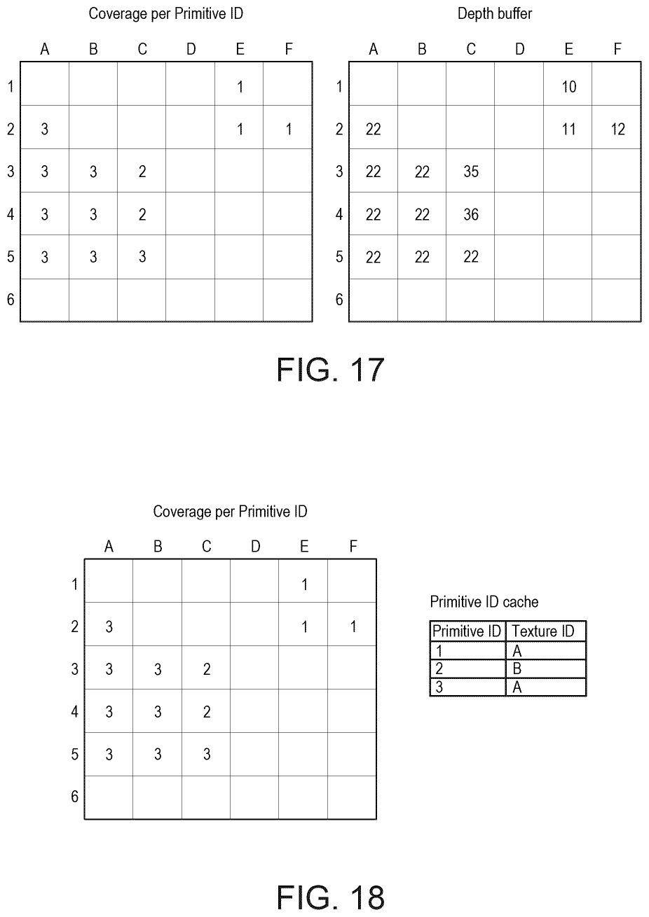

The initial processing pass will thus process these primitives (and in embodiments only these primitives) to populate the set of fragment visibility and depth buffer for this tile. FIG. 17 thus shows the result of depth buffer and the fragment visibility information, i.e. the coverage per primitive ID, at the end of the initial processing pass. In particular, as shown in FIG. 17, the coverage per primitive ID identifies (directly) which primitives are visible at which sampling positions within the tile.

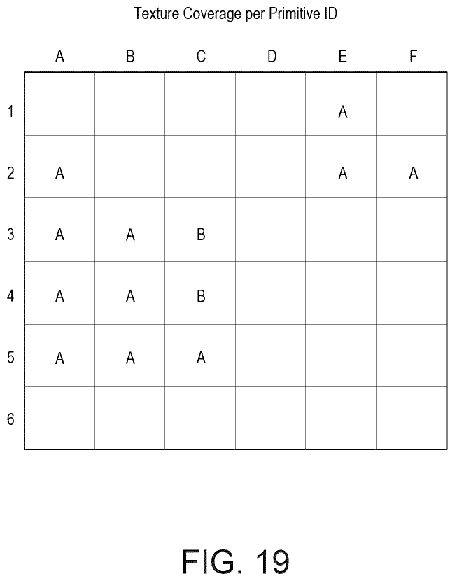

From this information, it can then be determined which graphics texture data needs to be applied at which sampling positions. For instance, FIG. 18 shows an example of a primitive ID descriptor cache (i.e. the primitive ID descriptor cache 1713 in FIG. 13) that is effectively a lookup table for which primitives use which textures. FIG. 19 shows another embodiment where the texture coverage per primitive ID is explicitly generated based on this (e.g. by iterating over the coverage per primitive ID).

This information as to which texture are visible at which sampling positions, however it is generated, can then be used as discussed above to control the order in which sampling positions are processed, in particular to (try to) process sampling positions where the same texture data is required relatively closer together, e.g. in consecutive order. This can then reduce the memory bandwidth and/or processing latency associated with the graphics texturing operations associated with the processing of those sampling positions since the cache hit rate can be increased, thus reducing the need to repeatedly re-fetch and re-process the (same) graphics texture data.

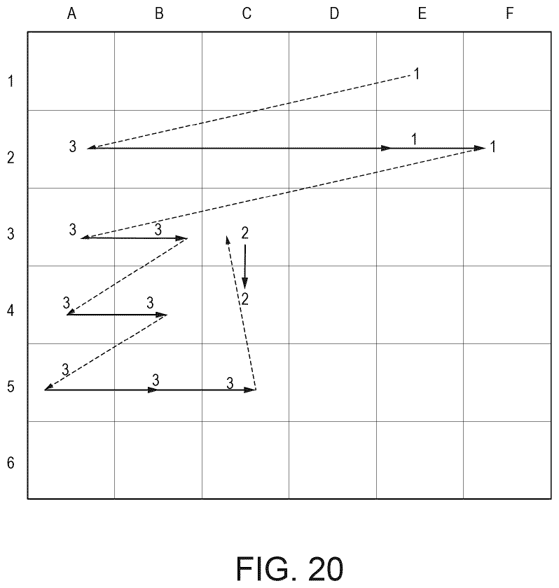

Thus, as shown in FIG. 20, in this example, the order in which sampling positions are processed is controlled such that sampling positions that need the same texture data are processed consecutively.

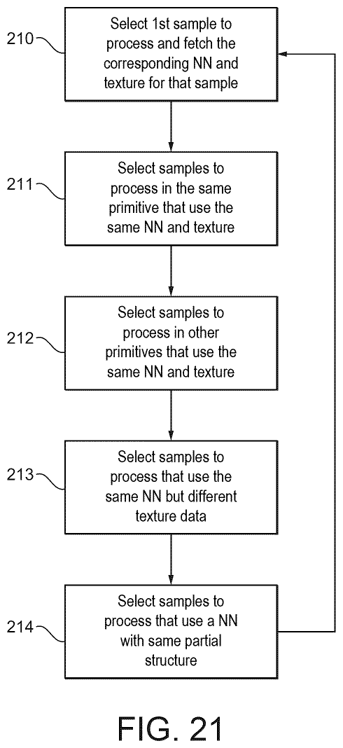

In this example, the order is controlled based on which sampling positions require the same graphics texture data. Various heuristics may however be applied in this regard to control the order in which sampling positions are processed during the further processing pass. FIG. 21 shows an example of a set of heuristics that may be cumulatively applied to determine the order in which sampling positions should be processed.

Thus, as shown in FIG. 21, for a given (first) sampling position that has been selected for processing, the required texture data and corresponding neural network for processing that texture are loaded in (step 210) (and the processing of that sampling position can then be performed accordingly). In the next step, the determination looks for other sampling positions within the same primitive that use the same texture (and hence can be processed using the same neural network), and selects those sampling positions accordingly for processing (step 211). Once all sampling positions within the same primitive that use the same texture and same neural network have been processed, the determination may then look for sampling positions in other primitives that use the same neural network and same texture, and select those sampling positions for processing (step 212). Once all sampling positions that use the same neural network and same texture have been selected (and processed), the determination may then look for and select for processing sampling positions that use the same neural network but for different texture data (i.e. with different input data) (step 213). The determination in this example thus avoids having to repeatedly load that same neural network into the graphics processor by attempting to select sampling positions that can be processed using the same neural network for processing in consecutive order.

At some point all of the sampling positions that can be processed with that same neural network will have been processed. However, before switching to another neural network, the determination in FIG. 21 checks then whether there are any sampling positions for which the required neural network has the same partial structure (e.g. it has some layers in common with the currently loaded neural network) (step 214). If so, the processing should then move to those sampling positions, as this at least avoids having to load the full neural network into the graphics processor.

Various other arrangements would be possible in this regard.

It will be appreciated that the set of visibility information generated from processing of primitives by the initial processing pass may also be suitably used to perform other control operations for the corresponding further processing pass, as desired. For example, the set of visibility information generated from processing of primitives by the initial processing pass may also be used to control how the graphics texture data is obtained in response to a texturing request issued by the graphics processor.

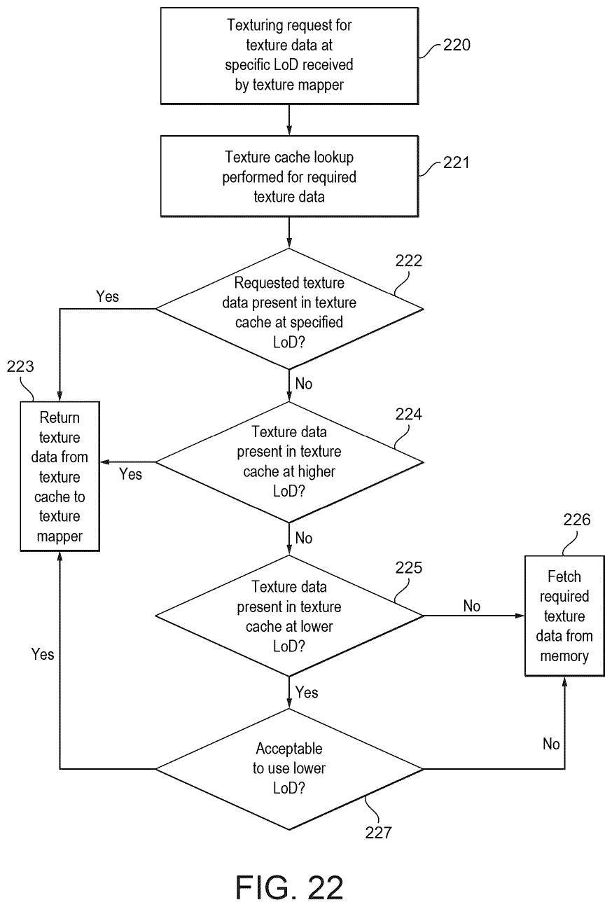

FIG. 22 is a flow chart showing an example of how the operation of the texture cache system may be controlled during the further processing pass in response to a texturing request for a particular instance of texture data.

Thus, as shown in FIG. 22, during the further processing pass, the fragment shader 12 may encounter a texturing instruction (operation) that is required to be executed by the texture mapper 14. When a texturing instruction is encountered by the fragment shader 12, a texturing message is sent from the fragment shader 12 to the texture mapper 14, requesting the texture mapper 14 to follow one or more texturing instructions to perform texture processing (step 220).

As described above, the texturing request received by the texture mapper 14 may then trigger the texture cache lookup unit 17 of the texture mapper 14 to check whether the required texture data is already available in the texture cache system 21 (step 221), and in particular to check whether the required texture data in particular in the second (texel) cache 23 of the texture cache system 21.

The texturing request will in particular check whether the requested texture data is present in the second (texel) cache 23 of the texture cache system 21 at the appropriate level(s) of detail specified in the texturing request. If the requested texture data is present in the second (texel) cache 23 of the texture cache system 21 at the appropriate level(s) of detail specified in the texturing request (step 222—yes), the texture data is then returned accordingly from the second (texel) cache 23 to the texture mapper 14 (step 223), and ultimately to the fragment shader 12.

In more traditional texture cache operation, if the requested texture data is not present in the second (texel) cache 23 of the texture cache system 21 at the appropriate level(s) of detail specified in the texturing request (step 222—no), a request is then made to fetch the required data from memory (or from a lower level of the texture cache system 21, as the case may be) into the second (texel) cache 23. According to the embodiment in FIG. 22, however, before triggering this ‘miss’ operation, it is further determined whether another instance of the (same type of) requested graphics texture data is present in the second (texel) cache 23 of the texture cache system 21 that could be returned, even if that instance of the (same type of) requested graphics texture data is present at a different level or levels of detail to those specified in the texturing request.

Thus, as shown in FIG. 22, if the requested texture data is not present in the second (texel) cache 23 of the texture cache system 21 at the appropriate level(s) of detail specified in the texturing request (step 222—no), it is then checked whether another instance of the (same type of) requested graphics texture data is present in the second (texel) cache 23 of the texture cache system 21 at a higher level of detail than the level(s) of detail specified in the texturing request.

If so (step 224—yes), the texture data can be returned to the texture mapper 14 at the higher level of detail, as this should be acceptable (as using the higher level of detail should not (negatively) impact the resulting image quality).

If not (step 224—no), it is then checked whether another instance of the (same type of) requested graphics texture data is present in the second (texel) cache 23 of the texture cache system 21 at a lower level of detail than the level(s) of detail specified in the texturing request. If there is no other instance of the (same type of) requested graphics texture data present in the second (texel) cache 23 of the texture cache system 21 (at any level of detail), the requested texture data must be fetched from memory, and so at this point an appropriate request is then made to fetch the required data from memory (or from a lower level of the texture cache system 21, as the case may be) into the second (texel) cache 23 (step 226).

On the other hand, if there is another instance of the (same type of) requested graphics texture data is present in the second (texel) cache 23 of the texture cache system 21 at a lower level of detail than the level(s) of detail specified in the texturing request (step 225—yes), before attempting to fetch the requested texture data at the correct level(s) of detail, it is checked whether it is acceptable to return the available texture data to the texture mapper 14 at the lower level of detail.

For instance, even if the other instance of the (same type of) requested graphics texture data is present in the second (texel) cache 23 of the texture cache system 21 at a lower level of detail than the level(s) of detail specified in the texturing request, such that is may be considered inappropriate to return that graphics texture data as this may (negatively) impact the resulting image quality, in some cases, particularly if it can be determined that the particular instance of graphics texture data has relatively lower visual impact, it may be acceptable to return the available texture data to the texture mapper 14 at the lower level of detail.

Thus, if it can be determined that the particular instance of graphics texture data has lower visual impact, such that it is acceptable to use the texture data at the lower level of detail (step 227—yes), the available texture data is then returned to the texture mapper 14 at the lower level of detail (step 223). If not (step 227—no), an appropriate request is then made to fetch the required data from memory (or from a lower level of the texture cache system 21, as the case may be) into the second (texel) cache 23 (step 226).

In this way, control is performed over the texture cache lookup operation to try to re-use graphics texture data that is already present in the second (texel) cache 23 of the texture cache system 21 when it is appropriate to do so (even if the exact graphics texture data at the appropriate level(s) of detail is not present). This then helps to reduce processing burden and/or memory bandwidth associated with the texturing operations.

In particular, the determining whether it is acceptable to use the texture data at the lower level of detail (in step 227), i.e. the determining of the expected visual impact of a particular instance of graphics texture data, can be made based on the information gathered by the initial processing pass (which information can then be signalled accordingly to the texture mapper 14 and/or texture cache system 21 to control the operation thereof in the manner discussed above).

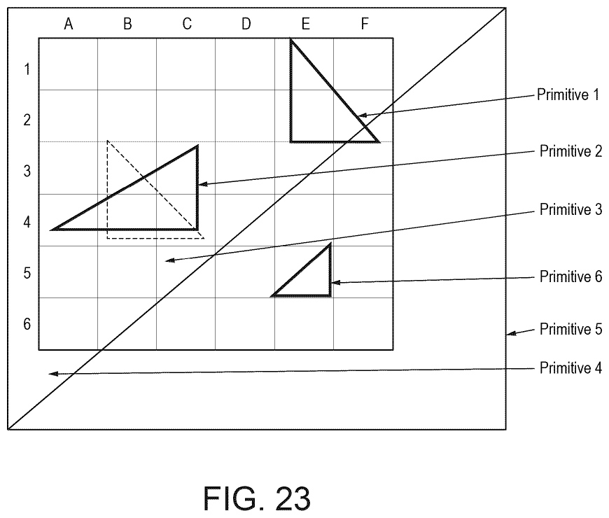

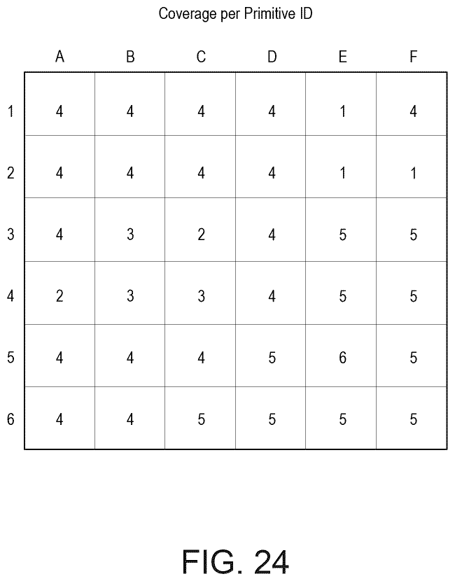

For example, FIG. 23 shows another example tile to be rendered in which there are six primitives with that tile. FIG. 24 then shows the results of an initial processing pass according to the technology described herein in which a fragment visibility buffer is generated. As can be seen from FIG. 4, Primitive 6 is only visible at single sampling position, and this sampling position is outside the expected foveal region within the centre of the image. Thus, the graphics texture associated with Primitive 6 is expected to have relatively lower visual impact. In contrast, Primitive 4 is visible at many sampling positions including in the expected foveal region within the centre of the image and so has relatively greater visual impact. On this basis, it may thus be determined that the particular instance of graphics texture data associated with Primitive 6 has relatively lower visual impact, and so it may be appropriate to use a lower level of detail (if one is available).

Various other examples would be possible in this regard.

For instance, in FIG. 22 the operation of the texture cache lookup 17 is controlled. It would also be possible, however, to control the generation (and content) of the texturing requests that are sent from the fragment shader 12 to the texture mapper 14 in the first place based on the information gathered by the initial processing pass and to control the manner in which texture data is obtained, e.g., and in particular, to control the level or levels of detail at which the texture data is obtained to re-use texture data at the same level of detail when it is possible and appropriate to do so.

Whilst in FIG. 22 the operation is performed to control the level or levels of detail at which the texture data is obtained, similar benefits may be achieved by controlling the neural network based texture decompression. For example, as discussed above, when neural network based texture decompression is being performed, if new graphics texture data needs to be fetched in, the corresponding neural network data or data structures for processing that graphics texture data also (first) need to be loaded in (e.g. to the neural buffer 179 of the neural engine 178) so that the graphics texture data can be processed accordingly.

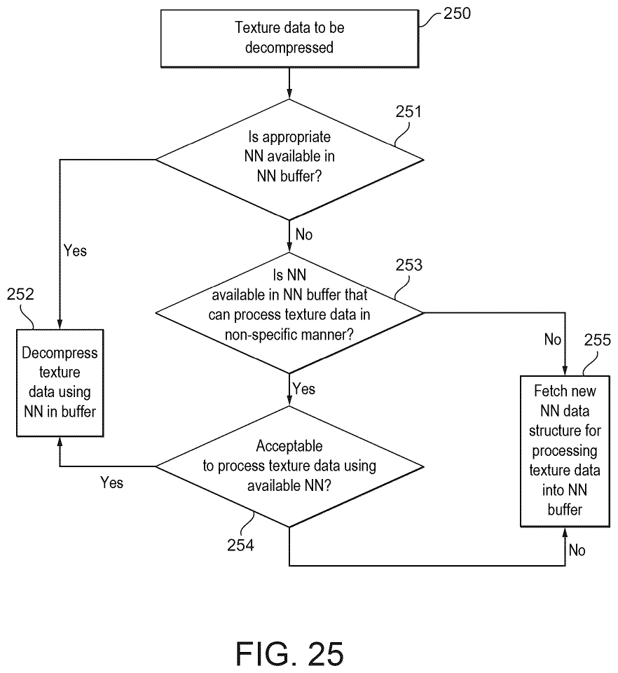

FIG. 25 is a flow chart showing an example of how neural network based texture processing may be controlled during the further processing pass.

Thus, as shown in FIG. 25, for a particular instance of texture data that is to be decompressed (step 250), it is first checked whether the corresponding neural network data or data structures for processing that particular instance of graphics texture data are already available in the neural buffer 179 of the neural engine 178. If so (step 251—yes), the graphics texture data is processed accordingly using the neural network that is already available in the neural buffer 179 (step 252).

On the other hand, if the corresponding neural network data or data structures for processing that particular instance of graphics texture data are not already available in the neural buffer 179 (step 251—no), rather than always fetching in the relevant neural network data or data structures, it is first checked whether there are any neural network data or data structures already available in the neural buffer 179 that could be used to process the particular instance of graphics texture data, albeit in a less optimal manner (i.e. since those neural network data or data structures may not be specifically configured for processing the particular instance of graphics texture data at the specified level(s) of detail, etc.). If no such neural network data or data structures are available in the neural buffer 179 (step 253—no), the appropriate neural network data or data structures are fetched into the neural buffer 179 (step 255) and the graphics texture data can subsequently be processed accordingly.

Whereas, if there are neural network data or data structures already available in the neural buffer 179 that could be used to process the particular instance of graphics texture data, albeit in a less optimal manner (step 253—yes), it is then checked whether or not it is acceptable to process the particular instance of graphics texture data using some or all of the neural network data or data structures already available in the neural buffer 179. If not (step 254—no), the appropriate neural network data or data structures are fetched into the neural buffer 179 (step 255) and the graphics texture data can subsequently be processed accordingly.

However, if it is determined that it is acceptable to process the particular instance of graphics texture data using some or all of the neural network data or data structures already available in the neural buffer 179 (step 254—yes), the graphics texture data is processed accordingly using the neural network that is already available in the neural buffer 179 (step 252).

Again, this determination whether it is acceptable to process the particular instance of graphics texture data using some or all of the neural network data or data structures already available in the neural buffer 179 (i.e. in step 254) is in embodiments performed based on the expected visual impact of a particular instance of graphics texture data, which as described above can be made based on the information gathered by the initial processing pass.

It will be seen from the above that the present embodiments may therefore provide improved graphics processor operation in which the rendering operations are performed in two separate passes, and in which information generated by the initial processing pass is then used to control the further processing pass. For example, this can then provide various benefits in terms of reduced overall memory bandwidth and/or increased processing throughput (reduced latency) associated with handling graphics processing texturing requests.

The foregoing detailed description has been presented for the purposes of illustration and description. It is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processing system comprising a graphics processor operable to generate render outputs and a texture data processing system including a texture cache that is operable to transfer graphics texture data between a memory system in which graphics texture data is stored and the graphics processor, the method comprising:
for a sequence of primitives to be processed for a render output:
the graphics processor:
performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
thereafter performing a further processing pass to generate respective output values for the respective sampling positions within the render output, the further processing pass comprising, for respective sampling positions for which an output value is to be generated, performing further processing of the particular primitive in the sequence of primitives that is visible at that sampling position to generate a respective output value for the sampling position, the further processing including the graphics processor obtaining graphics texture data associated with the primitive from the texture data processing system and applying the obtained graphics texture data to the sampling position,
wherein a set of information is generated from the processing of the sequence of primitives by the initial processing pass that is usable to identify which graphics texture data is to be applied during the further processing pass at which sampling positions within the render output,
and wherein the method further comprises:
controlling how the graphics texture data that is to be applied to one or more sampling positions within the render output during the further processing pass is obtained from the texture data processing system based on the set of information generated from the processing of the sequence of primitives by the initial processing pass.

2. The method of claim 1, wherein for an instance of graphics texture data to be applied to a sampling position during the further processing pass, the method comprises:
the graphics processor issuing to the texture data processing system a corresponding texturing request for that instance of graphics texture data, the texturing request specifying a particular graphics texture that is required and one or more level(s) of detail at which that particular graphics texture is required,
wherein when the particular requested graphics texture is already available in the texture cache at a higher level of detail than the level(s) of detail specified by the texturing request:
the method comprises:
returning the graphics texture at the higher level of detail.

3. The method of claim 1, wherein for an instance of graphics texture data to be applied to a sampling position during the further processing pass, the method comprises:
the graphics processor issuing to the texture data processing system a corresponding texturing request for that instance of graphics texture data, the texturing request specifying a particular graphics texture that is required and one or more level(s) of detail at which that particular graphics texture is required,
wherein when the particular requested graphics texture is already available in the texture cache at a lower level of detail than the level(s) of detail specified by the texturing request:
the method comprises:
further determining whether or not the graphics texture should be returned at the lower level of detail.

4. The method of claim 3, wherein the further determining whether or not the graphics texture should be returned at the lower level of detail is based on an expected impact of the particular instance of graphics texture data that is being requested, the expected impact being determined using the set of information generated from the processing of the sequence of primitives by the initial processing pass.

5. The method of claim 4, wherein the graphics texture should be returned at the lower level of detail when it is determined that the particular instance of graphics texture data that is being requested has a lower expected impact, wherein the particular instance of graphics texture data that is being requested is determined to have a lower expected impact based on one or more of:
the particular instance of graphics texture data being visible only at sampling positions outside an expected foveal region of the render output;
the particular instance of graphics texture data being visible at fewer than a threshold number of sampling positions;
the particular instance of graphics texture data being visible at fewer than a threshold number of adjacent sampling positions;
the primitive that is visible at the sampling position or positions to which the particular instance of graphics texture data is to be applied being partially transparent; and
the sampling position or positions to which the particular instance of graphics texture data is to be applied being covered by another partially transparent primitive.

6. The method of claim 1, wherein graphics texture data is stored in the memory system in compressed format, and wherein the graphics processor supports neural network based texture processing in which when compressed graphics texture data is loaded into the graphics processor during the further processing pass, the graphics texture data is processed into an uncompressed format for use by the graphics processor by one or more neural network(s), the texture data processing system comprising or having access to storage for storing the required data or data structures for executing the one or more neural network(s), and wherein, when a particular instance of compressed graphics texture data is to be processed into an uncompressed format for use by the graphics processor by executing one or more neural network(s), the method comprises:
determining whether required data or data structures for a corresponding set of neural network(s) that is configured for processing the particular instance of compressed graphics texture data are already available in the storage of the texture data processing system; and
when it is determined that some or all of the required data or data structures for the corresponding set of neural network(s) that is configured for processing the particular instance of compressed graphics texture data are not already available in the storage of the texture data processing system:
determining whether the particular instance of graphics texture data should nonetheless be processed using some or all of the data or data structures that are already available in the storage of the texture data processing system.

7. The method of claim 6, wherein the determination of whether the particular instance of graphics texture data should nonetheless be processed using some or all of the data or data structures that are already available in the storage of the texture data processing system is based on an expected impact of the particular instance of graphics texture data that is to be processed, the expected impact being determined using the set of information generated from the processing of the sequence of primitives by the initial processing pass.

8. The method of claim 7, wherein the particular instance of graphics texture data should nonetheless be processed using some or all of the data or data structures that are already available in the storage of the texture data processing system when it is determined that the particular instance of graphics texture data that is to be processed has a lower expected impact, wherein the particular instance of graphics texture data to be processed is determined to have a lower expected impact based on one or more of:
the particular instance of graphics texture data being visible only at sampling positions outside an expected foveal region of the render output;
the particular instance of graphics texture data being visible at fewer than a threshold number of sampling positions;
the particular instance of graphics texture data being visible at fewer than a threshold number of adjacent sampling positions;
the primitive that is visible at the sampling position or positions to which the particular instance of graphics texture data is to be applied being partially transparent; and
the sampling position or positions to which the particular instance of graphics texture data is to be applied being covered by another partially transparent primitive.

9. The method of claim 1, wherein controlling how the graphics texture data that is to be applied to one or more sampling positions within the render output during the further processing pass is obtained from the texture data processing system based on the set of information generated from the processing of the sequence of primitives by the initial processing pass comprises controlling a level or levels of detail at which the graphics texture data is obtained.

10. The method of claim 1, wherein for an instance of graphics texture data to be applied to a sampling position during the further processing pass, the method comprises:
the graphics processor issuing to the texture data processing system a corresponding texturing request for that instance of graphics texture data, and
wherein controlling how the graphics texture data that is to be applied to one or more sampling positions within the render output during the further processing pass is obtained from the texture data processing system comprises:
controlling information that is included into the texturing request based on the set of information generated from the processing of the sequence of primitives by the initial processing pass.

11. A graphics processing system comprising:
a graphics processor operable to generate render outputs; and
a texture data processing system including a texture cache that is operable to transfer graphics texture data between a memory system in which graphics texture data is stored and the graphics processor,
wherein the graphics processor comprises:
a rendering circuit that is operable to process primitives into respective sets of one or more fragments, each fragment associated with a respective set of one or more sampling positions within the render output, and which rendering circuit is further operable to process the resulting fragments to generate respective output values for the respective sampling positions within the render output; and
a rendering control circuit that is configured to control the operation of the graphics processor to generate a render output, wherein:
for a sequence of primitives to be processed for a render output:
the rendering control circuit causes the graphics processor to process the sequence of primitives by, using the rendering circuit:
performing an initial processing pass comprising processing primitives within the sequence of primitives into respective sets of one or more fragments, each fragment associated with a respective set of one or more sampling positions within the render output, and then processing the resulting fragments to determine which particular primitives in the sequence of primitives are visible for which sampling positions within the render output; and
thereafter performing a further processing pass to generate respective output values for the respective sampling positions within the render output, the further processing pass comprising, for respective sampling positions for which an output value is to be generated, performing further processing of the particular primitive in the sequence of primitives that is visible at that sampling position to generate a respective output value for the sampling position, the further processing including the graphics processor obtaining graphics texture data associated with the primitive from the texture data processing system and applying the obtained graphics texture data to the sampling position,
the graphics processing system further comprising a texturing control circuit that is configured to:
when the graphics processor is performing a further processing pass for a sequence of primitives for which a corresponding initial processing pass has already been performed, wherein a set of information is generated from the processing of the sequence of primitives by the initial processing pass that is usable to identify which graphics texture data is to be applied during the further processing pass at which sampling positions within the render output,
in response to requests from the graphics processor for instances graphics texture data from the texture data processing system:
control how the graphics texture data that is to be applied to one or more sampling positions within the render output during the further processing pass is obtained from the texture data processing system based on the set of information generated from the processing of the sequence of primitives by the initial processing pass.

12. The graphics processing system of claim 11, wherein for an instance of graphics texture data to be applied to a sampling position during the further processing pass:
the graphics processor is configured to issue to the texture data processing system a corresponding texturing request for that instance of graphics texture data, the texturing request specifying a particular graphics texture that is required and one or more level(s) of detail at which that particular graphics texture is required,
wherein when the particular requested graphics texture is already available in the texture cache at a higher level of detail than the level(s) of detail specified by the texturing request:
the texture data processing system is configured to:
return the graphics texture at the higher level of detail.

13. The graphics processing system of claim 11, wherein for an instance of graphics texture data to be applied to a sampling position during the further processing pass:
the graphics processor is configured to issue to the texture data processing system a corresponding texturing request for that instance of graphics texture data, the texturing request specifying a particular graphics texture that is required and one or more level(s) of detail at which that particular graphics texture is required,
wherein when the particular requested graphics texture is already available in the texture cache at a lower level of detail than the level(s) of detail specified by the texturing request:
the texture data processing system is configured to:
further determine whether or not the graphics texture should be returned at the lower level of detail.

14. The graphics processing system of claim 13, wherein the further determining whether or not the graphics texture should be returned at the lower level of detail is based on an expected impact of the particular instance of graphics texture data that is being requested, the expected impact being determined using the set of information generated from the processing of the sequence of primitives by the initial processing pass.

15. The graphics processing system of claim 14, wherein the graphics texture should be returned at the lower level of detail when it is determined that the particular instance of graphics texture data that is being requested has a lower expected impact, wherein the particular instance of graphics texture data that is being requested is determined to have a lower expected impact based on one or more of:
the particular instance of graphics texture data being visible only at sampling positions outside an expected foveal region of the render output;
the particular instance of graphics texture data being visible at fewer than a threshold number of sampling positions;
the particular instance of graphics texture data being visible at fewer than a threshold number of adjacent sampling positions;
the primitive that is visible at the sampling position or positions to which the particular instance of graphics texture data is to be applied being partially transparent; and
the sampling position or positions to which the particular instance of graphics texture data is to be applied being covered by another partially transparent primitive.

16. The graphics processing system of claim 11, wherein graphics texture data is stored in the memory system in compressed format, and wherein the graphics processor supports neural network based texture processing in which when compressed graphics texture data is loaded into the graphics processor during the further processing pass, the graphics texture data is processed into an uncompressed format for use by the graphics processor by one or more neural network(s), the texture data processing system comprising or having access to storage for storing the required data or data structures for executing the one or more neural network(s), and wherein, when a particular instance of compressed graphics texture data is to be processed into an uncompressed format for use by the graphics processor by executing one or more neural network(s), the texturing control circuit is configured to:
determine whether required data or data structures for a corresponding set of neural network(s) that is configured for processing the particular instance of compressed graphics texture data are already available in the storage of the texture data processing system; and
when it is determined that some or all of the required data or data structures for the corresponding set of neural network(s) that is configured for processing the particular instance of compressed graphics texture data are not already available in the storage of the texture data processing system:
determine whether the particular instance of graphics texture data should nonetheless be processed using some or all of the data or data structures that are already available in the storage of the texture data processing system.

17. The graphics processing system of claim 16, wherein the determination of whether the particular instance of graphics texture data should nonetheless be processed using some or all of the data or data structures that are already available in the storage of the texture data processing system is based on an expected impact of the particular instance of graphics texture data that is to be processed, the expected impact being determined using the set of information generated from the processing of the sequence of primitives by the initial processing pass,
wherein the particular instance of graphics texture data should nonetheless be processed using some or all of the data or data structures that are already available in the storage of the texture data processing system when it is determined that the particular instance of graphics texture data that is to be processed has a lower expected impact, wherein the particular instance of graphics texture data to be processed is determined to have a lower expected impact based on one or more of:
the particular instance of graphics texture data being visible only at sampling positions outside an expected foveal region of the render output;
the particular instance of graphics texture data being visible at fewer than a threshold number of sampling positions;
the particular instance of graphics texture data being visible at fewer than a threshold number of adjacent sampling positions;
the primitive that is visible at the sampling position or positions to which the particular instance of graphics texture data is to be applied being partially transparent; and
the sampling position or positions to which the particular instance of graphics texture data is to be applied being covered by another partially transparent primitive.

18. The graphics processing system of claim 11, wherein controlling how the graphics texture data that is to be applied to one or more sampling positions within the render output during the further processing pass is obtained from the texture data processing system based on the set of information generated from the processing of the sequence of primitives by the initial processing pass comprises controlling a level or levels of detail at which the graphics texture data is obtained.

19. The graphics processing system of claim 11, wherein for an instance of graphics texture data to be applied to a sampling position during the further processing pass:
the graphics processor is configured to issue to the texture data processing system a corresponding texturing request for that instance of graphics texture data, and
wherein controlling how the graphics texture data that is to be applied to one or more sampling positions within the render output during the further processing pass is obtained from the texture data processing system comprises:
controlling information that is included into the texturing request based on the set of information generated from the processing of the sequence of primitives by the initial processing pass.

20. A non-transitory computer readable medium storing computer program instructions that when executed by one or more processor will cause the processor to perform the method of claim 1.
